(19) United States
(12) Patent Application Publication
(10) Pub. No.: US 2013/0102463 A1
(43) Pub. Date: Apr. 25, 2013

(54) Herbicidal Compositions

(71) Applicants: Thomas Ehrhardt, Speyer (DE); Klaus Grossmann, Neuhofen (DE); Johannes Hutzler, Waldsee (DE); Anja Simon, Weinheim (DE); Sylke Haremza, Neckargemuend (DE); Michael Ishaque, Mannheim (DE); Trevor William Newton, Neustadt (DE); Robert Reinhard, Limburgerhof (DE); Steven Bowe, Apex, NC (US); Kyle Keller, Rougemont, NC (US); Phil Munger, Visalia, CA (US)

(72) Inventors: Thomas Ehrhardt, Speyer (DE); Klaus Grossmann, Neuhofen (DE); Johannes Hutzler, Waldsee (DE); Anja Simon, Weinheim (DE); Sylke Haremza, Neckargemuend (DE); Michael Ishaque, Mannheim (DE); Trevor William Newton, Neustadt (DE); Robert Reinhard, Limburgerhof (DE); Steven Bowe, Apex, NC (US); Kyle Keller, Rougemont, NC (US); Phil Munger, Visalia, CA (US)

(73) Assignee: BASF SE, Ludwigshafen (DE)

(21) Appl. No.: 13/805,554

(22) PCT Filed: Jun. 21, 2011
(86) PCT No.: PCT/EP2011/060348

§ 371 Date: Dec. 19, 2012

Related U.S. Application Data
(60) Provisional application No. 61/358,022, filed on Jun. 24, 2010.

(30) Foreign Application Priority Data
Jun. 24, 2010 (EP) 10167212.9

(51) Int. Cl. A01N 43/54

(52) U.S. Cl. CPC A01N 43/54
USPC 504/103; 504/136

(57) ABSTRACT

The present invention relates to herbicidal compositions comprising as herbicide A at least one protoporphyrinogen-IX oxidase inhibitor (PPO inhibitor), and at least one light detoxifying compound B, compositions comprising them and their use as herbicides, i.e. for controlling harmful plants, and also a method for controlling unwanted vegetation which comprises allowing a herbicidal effective amount of said herbicidal composition to act on plants, their seed and/or their habitat.

The present application relates to herbicidal compositions comprising as herbicide A at least one protoporphyrinogen-IX oxidase inhibitor (PPO inhibitor), and at least one light detoxifying compound B.

The herbicides A are known as herbicides in agricultural, industrial and recreational areas. However, the herbicidal properties of these known compounds with regard to the harmful plants are not always entirely satisfactory.

It is an object of the present invention to provide herbicidal compositions which are highly active against unwanted harmful plants. In addition, the compositions according to the invention should have a broad spectrum of activity.

Surprisingly it has been found that the application of a composition comprising at least one herbicide A and at least one light detoxifying compound B show an enhanced herbicidal activity against unwanted plants.

The present invention therefore relates to an herbicidal composition comprising
a) at least one herbicide A selected from the group consisting of protoporphyrinogen-IX oxidase inhibitors (PPO inhibitors), or at least one agriculturally acceptable salt or derivative thereof, and
b) at least one light detoxifying compound B.

The present invention also provides herbicidal compositions in the form of herbicidal active crop protection compositions comprising at least one PPO inhibitor, at least one light detoxifying compound B and at least one auxiliary customary for formulating crop protection agents and a process for the preparation of such compositions.

Furthermore the present invention relates to a method for controlling unwanted vegetation which comprises allowing an herbicidal active amount of at least one herbicidal composition according to the present invention to act on plants, their environment or on seed, e.g. by applying a composition comprising at least one PPO inhibitor and at least one light detoxifying compound B to unwanted vegetation, crops, crop seed or other crop propagating organs.

The preferred embodiments of the invention mentioned herein below have to be understood as being preferred either independently from each other or in combination with one another.

PPO inhibitors (herbicides A according to the present invention) are compounds which herbicidal activity is based on the inhibition of the protoporphyrinogen-IX-oxidase, a key step in chlorophyll biosynthesis in plants and which belong to the group E of the HRAC classification system (see HRAC, Classification of Herbicides According to Mode of Action, http://www.plantprotection.org/hrac/MOA.html).

Examples of herbicides A according to the present invention are: acifluorfen, acifluorfen-sodium, azafenidin, bencarbazone, benzfendizone, bifenox, butafenacil, carfentrazone, carfentrazone-ethyl, chlomethoxyfen, cinidon-ethyl, ethoxyfen-ethyl, fluazolate, flufenpyr, flufenpyr-ethyl, flumiclorac, flumiclorac-pentyl, flumioxazin, fluoroglycofen, fluoroglycofen-ethyl, fluthiacet, fluthiacet-methyl, fomesafen, halosafen, lactofen, oxadiargyl, oxadiazon, oxyfluorfen, pentoxazone, profluazol, pyraclonil, pyraflufen, pyraflufen-ethyl, saflufenacil, sulfentrazone, thidiazimin, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethylphenoxy)-5-methyl-1H-pyrazole-1-carboxamide (CAS 915396-43-9), N-ethyl-3-(2-chloro-6-fluoro-4-trifluoromethyl-phenoxy)-5-methyl-1H-pyrazole-1-carboxamide (CAS 452099-05-7), N-tetrahydro-furfuryl-3-(2-chloro-6-fluoro-4-trifluoromethylphenoxy)-5-methyl-1H-pyrazole-1-carboxamide (CAS 45100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione and 1-Methyl-6-trifluoro-methyl-3-(2,2,7-trifluoro-3-oxo-4-prop-2-ynyl-3,4-dihydro-2H-benzo[1,4]oxazin-6-yl)-1H-pyrimidine-2,4-dione.

Preferred examples of herbicides A according to the present invention are: acifluorfen-sodium, bencarbazone, benzfendizone, butafenacil, carfentrazone-ethyl, cinidon-ethyl, flufenpyr-ethyl, flumiclorac-pentyl, flumioxazin, fluoroglycofen-ethyl, fomesafen, lactofen, oxadiargyl, oxadiazon, oxyfluorfen, pentoxazone, pyraflufen-ethyl, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), N-ethyl-3-(2,6-dichloro-4-trifluoromethylphenoxy)-5-methyl-1H-pyrazole-1-carboxamide (CAS 452098-92-9), N-tetrahydrofurfuryl-3-(2,6-dichloro-4-trifluoromethyl-phenoxy)-5-methyl-1H-pyrazole-1-carboxamide (CAS 915396-43-9), N-ethyl-3-(2-chloro-6-fluoro-4-trifluoromethylphenoxy)-5-methyl-1H-pyrazole-1-carboxamide (CAS 452099-05-7), N-tetrahydrofurfuryl-3-(2-chloro-6-fluoro-4-trifluoromethylphenoxy)-5-methyl-1H-pyrazole-1-carboxamide (CAS 45100-03-7), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione.

More preferred examples of herbicides A according to the present invention are: flumioxazin, oxyfluorfen, saflufenacil, sulfentrazone, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b][1,4]oxazin-6-yl)-1,3,5-triazinane-2,4-dione, 2-(2,2,7-Trifluoro-3-oxo-4-prop-2-ynyl-3,4-dihydro-2H-benzo[1,4]oxazin-6-yl)-4,5,6,7-tetrahydro-isoindole-1,3-dione, and 1-Methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione.

According to another embodiment of the present invention the herbicide A is preferably selected from the group consisting of
A.1 phenyluracil herbicides;
A.2 triazolone and oxadiazolone herbicides;
A.3 dicarboximide herbicides;
A.4 nitrophenylethers;
A.5 benzoxazinones; and
A.6 miscellaneous PPOs selected from the group consisting of ethoxyfen, fluazolate, pyraflufen, fluthiacet, thidiazimin, pentoxazone, pyraclonil, profluazol, flufenpyr and nipyraclofen.

Phenyluracil herbicides (group A.1) include benzfendizone and compounds of the formula I,

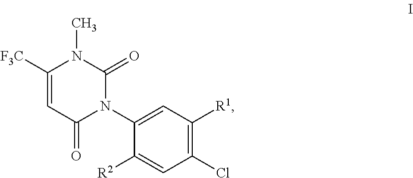

wherein
R¹ is selected from the group consisting of propargyloxy, allyloxy, isopropyloxy, C(═O)NHSO₂NR³R⁴, C(═O)N—NR³R⁴, C(═O)O—CR³R⁵—C(═O)—OR⁷, C(═O)O—R⁴, C(═O)O—CHR⁶—C(═O)NHSO₂NR³R⁴, NHSO₂NR³R⁴, SO₂NHC(═O)NR³R⁴, CH₂—CH(Cl)CO₂—R⁶OC(CH₃)₂—C(═O)—OR⁷, and

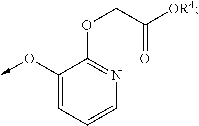

where
R³ is hydrogen or C₁-C₄-alkyl;
R⁴ is C₁-C₄-alkyl;
R⁵ is hydrogen or C₁-C₄-alkyl;
R⁶ is hydrogen or C₁-C₄-alkyl or a agriculturally acceptable cation;
R⁷ is C₁-C₄-alkyl, propargyl or allyl; and
R² is hydrogen, fluorine or chlorine;

and agriculturally acceptable salts or derivatives thereof.

According to another preferred embodiment of the invention, the herbicide A is selected from the group consisting of A.1 or an agriculturally acceptable salt or derivative thereof.

According to another preferred embodiment of the invention, the herbicidal compound A.1 comprises at least one compound of the formula I and agriculturally acceptable salts or derivatives, preferably at least one agriculturally acceptable salt or derivative, thereof.

Examples of the compounds of formula I include
butafenacil (R¹═C(═O)O—C(CH₃)₂—C(═O)—OCH₂CH═CH₂, R²═H),
flupropacil (R¹═C(═O)O—CH(CH₃)₂, R²═H), and
saflufenacil (R¹═C(═O)NHSO₂N(CH₃)(CH(CH₃)₂), R²═F)

According to another preferred embodiment of the invention preference is given to those compounds of formula I wherein the variables R¹ to R⁷ either independently of one another or in combination, have the meanings given below:
R¹ is selected from the group consisting of C(═O)NHSO₂NR³R⁴,
   C(═O)O—CR³R⁵—C(═O)—OR⁷ and

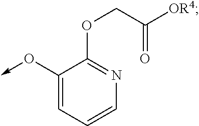

preferably C(═O)NHSO₂NR³R⁴;
also preferably C(═O)O—CR³R⁵—C(═O)—OR⁷;
R² is hydrogen, fluorine or chlorine;
   preferably hydrogen or fluorine;
   most preferred fluorine;
R³ is hydrogen or C₁-C₄-alkyl;
   preferably C₁-C₄-alkyl;
   most preferred methyl;
R⁴ is C₁-C₄-alkyl;
   preferably isopropyl;
   also preferably ethyl;
R⁵ is hydrogen or C₁-C₄-alkyl;
   preferably C₁-C₄-alkyl; and
R⁷ is C₁-C₄-alkyl, propargyl or allyl;
   preferably allyl.

Preferred herbicides A.1 are butafenacil and saflufenacil.

In a particular preferred embodiment of this invention, the herbicide A comprises or in particular is butafenacil.

In another particular preferred embodiment of the present invention, the herbicide A comprises or in particular is saflufenacil.

Phenyluracil herbicides (group A.1) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Triazolone and oxadiazolone herbicides (group A.2) preferably include compounds of the formula II and their salts

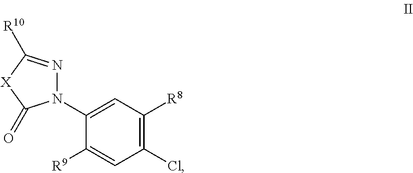

wherein
X is O or NR¹¹;
   where R¹¹ is CHF2, or together with R¹⁹ may form 1,4-butandiyl;
R⁸ is selected from the group consisting of propargyloxy, allyloxy, isopropyloxy, CH₂—CH(Cl)CO₂—R¹² and NH—SO₂—CH₃,
   where R¹² is hydrogen, C₁-C₆-alkyl or an agriculturally acceptable cation;
R⁹ is fluorine or chlorine; and
R¹⁰ is CH₃, tert.-butyl.

Examples of the compounds of formula II include azafenidin, carfentrazone, sulfentrazone, oxadiazon and oxadiargyl. Also included are the salts of carfentrazone, in particular its sodium salt, potassium salt, ammonium salt or substituted ammonium salts as defined above, in particular mono-, di and tri-C₁-C₈-alkylammonium salts such as isopropylammonium salts and the esters of carfentrazone, in particular its C₁-C₈-alkyl esters, such as methylesters, ethylesters, isopropyl esters. A suitable example of such an ester is carfentrazone-ethyl.

Triazolone and oxadiazolone herbicides (group A.2) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Dicarboximide herbicides (group A.3) include compounds of the formula III,

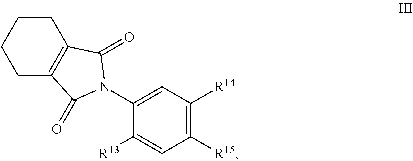

wherein
R¹³ is hydrogen, fluorine or chlorine;
R¹⁴ is selected from the group consisting of propargyloxy, allyloxy, isopropyloxy, 1-methyl-2-propinyloxy, O—CH₂CO₂—R¹⁶ and CH═C(Cl)CO₂—R¹⁶,
   where R¹⁶ is hydrogen, C₁-C₆-alkyl or an agriculturally acceptable cation; and
R¹⁵ is fluorine or chlorine.

Examples of compounds of formula III include cinidon, flumiclorac and flumipropyn. Also included are the salts of cinidon and flumiclorac, in particular their sodium salts, potassium salts, ammonium salts or substituted ammonium salts as defined above, in particular mono-, di and tri-C₁-C₈-alkylammonium salts such as isopropylammonium salts, and the esters of cinidon and flumiclorac, in particular their C₁-C₈-alkyl esters, such as methylesters, ethylesters, isopropyl esters. Suitable examples of such esters are cinidon-ethyl and flumiclorac-pentyl.

Dicarboximide herbicides (group A.3) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Nitrophenylether herbicides (group A.4) include furyloxyphen and compounds of the formula IV,

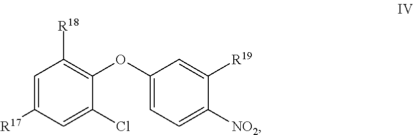

wherein
R¹⁷ is chlorine or trifluoro-methyl;
R¹⁸ is hydrogen, fluorine or chlorine;
R¹⁹ is selected from the group consisting of hydrogen, C₁-C₄-alkoxy, CO₂—R²⁰, C(═O)O—CH₂CO₂—R²⁰, C(═O)O—CH(CH₃)CO₂—R²⁰, C(═O)NH—SO₂—R²¹, and
   C₁-C₄-alkoxy-C(═O)NH—R²¹;
   where R²⁰ is hydrogen, C₁-C₆-alkyl or a agriculturally acceptable cation; and
      R²¹ is C₁-C₄-alkyl.

Examples of compounds of formula IV include nitrofen, bifenox, oxyfluorfen, acifluorfen, fluoroglycofen, fluorodifen, fomesafen, lactofen, halosafen, chlornitrofen, fluornitrofen, chlomethoxyfen, nitrofluorfen and ethipromid and their salts and esters. In particular included are the salts of acifluorfen and fluoroglycofen, in particular the sodium salts, potassium salts, ammonium salts or substituted ammonium salts as defined above, in particular mono-, di and tri-C₁-C₈-alkylammonium salts such as isopropylammonium salts and the esters of acifluorfen and fluoroglycofen, in particular their C₁-C₈-alkyl esters, such as methylesters, ethylesters, isopropyl esters. A suitable example of such a salt is acifluorfen-sodium. Suitable examples of such esters are acifluorfen-methyl and fluoroglycofen-ethyl.

Nitrophenylether herbicides (group A.4) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), and also from The Compendium of Pesticide Common Names http://www.alanwood.net/pesticides/.

Benzoxazinone herbicides (group A.5) include compounds of the formula V

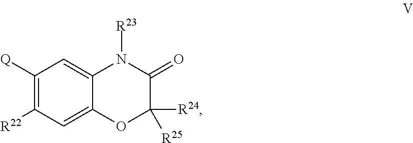

wherein
R²² is hydrogen or halogen; preferably halogen; more preferably fluorine; also preferably hydrogen;
R²³ is hydrogen, C₁-C₆-alkyl, C₁-C₆-haloalkyl, C₃-C₆-cycloalkyl, C₃-C₆-alkenyl, C₃-C₆-haloalkenyl, C₃-C₆-alkynyl, C₃-C₆-haloalkynyl, C₁-C₆-alkoxy or C₃-C₆-cycloalkyl-C₁-C₆-alkyl; preferably C₃-C₆-alkynyl; more preferably propargyl;
R²⁴ and R²⁵ independently of one another are hydrogen or halogen, preferably independently of one another are hydrogen or fluorine, more preferably R²⁴ and R²⁵ both are hydrogen, also more preferably R²⁴ and R²⁵ both are fluorine; and
Q is a heterocycle selected from the group consisting of Q¹ to Q³:

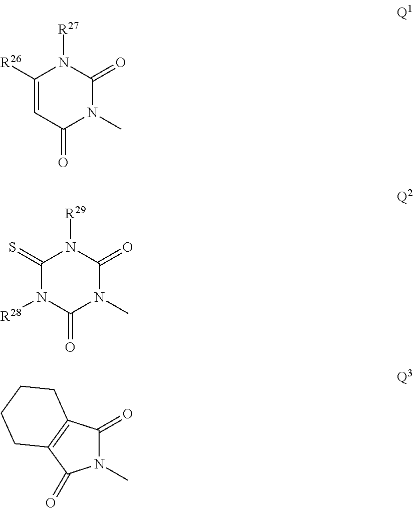

wherein
R²⁶ is hydrogen, C₁-C₆-alkyl or C₁-C₆-haloalkyl; preferably C₁-C₆-haloalkyl; more preferably CF3;
R²⁷ is hydrogen, NH₂, C₁-C₆-alkyl or C₃-C₆-alkynyl; preferably C₁-C₆-alkyl; more preferably CH₃;
R²⁸ is hydrogen or C₁-C₆-alkyl; preferably C₁-C₆-alkyl; more preferably CH₃;
R²⁹ hydrogen, NH₂, C₁-C₆-alkyl or C₃-C₆-alkynyl; preferably C₁-C₆-alkyl; more preferably CH₃.

Examples of compounds of formula V include 1-methyl-6-trifluoromethyl-3-(7-fluoro-3-oxo-4-prop-2-ynyl-3,4-dihydro-2H-benzo[1,4]oxazin-6-yl)-1H-pyrimidine-2,4-dione, 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b]-[1,4]oxazin-6-yl)-1,3,5-triazinane-2,4-dione, flumioxazin and 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione.

Benzoxazinone herbicides (group A.5) are known from e.g. G. Theodoridis “Protoporphyrinogen-IX-oxidase Inhibitors” in “Modern Crop Protection Compounds” Vol. 1, Wiley-VHC 2007, pp 153-186; C. D. S. Tomlin, “The Pesticide Manual”, 13th Edition, BCPC (2003), The Compendium of Pesticide Common Names http://www.alanwood.net/pesticides/, and also from WO 90/15057 and WO 02/066471.

According to another embodiment of the present invention the herbicide A is selected from the group consisting of A1, A.2, A3 and A5, preferably selected from saflufenacil, ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; S-3100), carfentrazone-ethyl, oxyfluorofen, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione and flumioxazin.

According to another embodiment of the present invention the herbicide A is preferably selected from the group consisting of A.1;

more preferably selected from saflufenacil and ethyl[3-[2-chloro-4-fluoro-5-(1-methyl-6-trifluoromethyl-2,4-dioxo-1,2,3,4-tetrahydropyrimidin-3-yl)phenoxy]-2-pyridyloxy]acetate (CAS 353292-31-6; 5-3100.

According to another embodiment of the present invention the herbicide A is preferably selected from the group consisting of A.2; more preferably selected from carfentrazone-ethyl.

According to another embodiment of the present invention the herbicide A is preferably selected from the group consisting of A.3.

According to another embodiment of the present invention the herbicide A is preferably selected from the group consisting of A.4; more preferably selected from oxyfluorofen.

According to another embodiment of the present invention the herbicide A is preferably selected from the group consisting of A.5; more preferably selected from 1-methyl-6-trifluoromethyl-3-(7-fluoro-3-oxo-4-prop-2-ynyl-3,4-dihydro-2H-benzo[1,4]oxazin-6-yl)-1H-pyrimidine-2,4-dione, 1-methyl-6-trifluoromethyl-3-(2,2,7-trifluoro-3-oxo-4-prop-2-ynyl-3,4-dihydro-2H-benzo[1,4]oxazin-6-yl)-1H-pyrimidine-2,4-dione, 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione, 1,5-dimethyl-6-thioxo-3-(2,2,7-trifluoro-3-oxo-4-(prop-2-ynyl)-3,4-dihydro-2H-benzo[b]-[1,4]oxazin-6-yl)-1,3,5-triazinane-2,4-dione, flumioxazin and 2-(2,2,7-trifluoro-3-oxo-4-prop-2-ynyl-3,4-dihydro-2H-benzo[1,4]oxazin-6-yl)-4,5,6,7-tetrahydro-isoindole-1,3-dione; especially preferably selected from 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione and flumioxazin.

The term “light detoxifying compound B” stands for a compound, which is capable to reduce the effect of light either by absorbing ultraviolet rays, by filtering ultraviolet rays or by detoxifying reactive oxygen species (ROS) generated under the influence of light in the plant.

According to the present invention the light detoxifying compound B is preferably selected from the group consisting of
B.1 UV absorbers;
B.2 inorganic UV filters; and
B.3 ROS detoxifying substances.

UV absorbers (group B.1) are organic compounds which can reduce light intensity by absorbing ultraviolet rays and give off the absorbed energy again in the form of longer-wave radiation, e.g. heat. The term “UV absorbers B.1” relates to one type or a mixture of different types of said compounds.

Examples for UV absorbers B.1, to which the present invention preferably relates, are selected from the group consisting of B.1.1 to B.1.17:
B.1.1 benzotriazoles, such as 2-(2H-benzotriazol-2-yl)-4,6-bis(1-methyl-1-phenyl-ethyl)phenol (Tinuvin® 900, CIBA AG), [3-[3-(2H-benzotriazol-2-yl)-5-(1,1-dimethylethyl)-4-hydroxyphenyl]-1-oxopropyl]-w-[3-[3-(2H-benzotriazol-2-yl)-5-(1,1-dimethylethyl)-4-hydroxyphenyl]-1-oxopropoxy]poly(oxy-1,2-ethanediyl) (Tinuvin® 1130, CIBA AG), 6-tert-butyl-2-(5-chloro-2H-benzotriazol-2-yl)-4-methylphenol (Tinuvin® 326, CIBA AG), 2,4-di-tert-butyl-6-(5-chloro-2H-benzo-triazol-2-yl)-phenol (Tinuvin® 327, CIBA AG), 2-(2H-benzotriazol-2-yl)-4,6-di-tert.-pentylphenol (Tinuvin® 320, CIBA AG), 2-(2H-benzotriazol-2-yl)-4-(1,1,3,3-tetramethylbutyl)-phenol (Tinuvin® 329, CIBA AG), 2-(2H-benzotriazol-2-yl)-4-methylphenol (Tinuvin® P, CIBA AG), 2-(2H-benzotriazol-2-yl)-4,6-bis(1-methyl-1-phenylethyl)phenol (Tinuvin® 234, CIBA AG), 2,2-Methylenbis-(6-(benzotriazol-2-yl)-4-tert-octylphenol (Tinuvin® 360, CIBA AG), 2-(2H-benzotriazol-2-yl)-2-(2-methylpropyl)phenol-4-sulfonic acid sodium salt (Tinogard H® P, CIBA AG), branched and linear 2-(2H-benzotriazol-2-yl)-6-dodecyl-4-methylphenol (Tinuvin® 171, Ciba AG), 2,2-methylenbis-6-(benzotriazol-2-yl)-4-tert-octylphenol (Tinosorb®M, BASF SE), 6-butyl-2-[2-hydroxy-3-(1-methyl-1-phenylethyl)-5-(1,1,3,3-tetramethylbutyl)-phenyl]-pyrrolo[3,4-f][benzotriazole-5,7(2H, 6H)-dione (Xymara®CarboProtect, BASF SE) and compounds of the formula VI

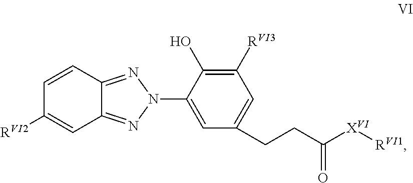

wherein
X^{VI} is NH or O;
R^{VI1} is [C₂-C₄-alkoxy]ₙ-(C₁-C₁₈-alkyl) or —[CH₂CH₂NH]ₙ—H,
   wherein n is an integer between 3 and 50;
R^{VI2} is H or Cl; and
R^{VI3} is H or C₁-C₈-alkyl;
B.1.2 cyanoacrylates, such as ethyl 2-cyano-3-phenylcinnamate (Uvinul® 3035, BASF SE), 2-cyano-3,3-diphenylacrylic acid-2′-ethylhexyl ester or 2-ethyl-hexyl 2-cyano-3-phenylcinnamate (octocrylene, Uvinul® 539 T, Uvinul® 3039, BASF SE), 2-cyano-3,3-diphenyl-, 2,2-bis[[(2-cyano-1-oxo-3,3-diphenyl-2-propenyl)-oxy]methyl]-1,3-propanediyl-2-propenoic acid ester (Uvinul® 3030, BASF SE), and compounds of the formula VII

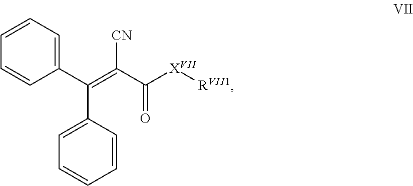

wherein
X^{VII} is NH or O; and
R^{VI1} is [C₂-C₄-alkoxy]ₙ—(C₁-C₁₈-alkyl) or —[CH₂CH₂NH]ₙ—H,
   wherein n is an integer between 3 and 50;
B.1.3 para-aminobenzoic acid (PABA) derivatives, especially esters, such as ethyl-PABA, ethoxylated PABA, ethyl-dihydroxypropyl-PABA, Glycerol-PABA, 2-ethylhexyl 4-(dimethylamino)benzoate, 2-octyl 4-(dimethylamino)benzoate, amyl 4-(dimethylamino)benzoate, 4-bis(polyethoxy)-4-amino benzoic acid polyethoxyethyl ester (Uvinul® P 25, BASF SE);
B.1.4 salicylic acid esters, such as 2-ethylhexyl salicylate, 4-isopropylbenzyl salicylate, homomethyl salicylate, TEA salicylate (Neo Heliopan® TS, Haarmann and Reimer), dipropyleneglycol salicylate;
B.1.5 cinnamic acid esters, such as 2-ethylhexyl 4-methoxycinnamate (Uvinul® MC 80), octyl-p-methoxycinnamate, propyl 4-methoxycinnamate, isoamyl 4-methoxycinnamate, conoxate, diisopropyl methylcinnamate, etocrylene (Uvinul® N 35, BASF SE), and compounds of the formula VIII

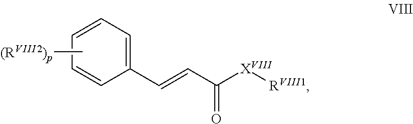

wherein
X^{VIII} is NH or O;
R^{VIII1} is H or [C₂-C₄-alkoxy]ₙ—(C₁-C₁₈-alkyl) or —[CH₂CH₂NH]ₙ—H,
   wherein n is an integer between 3 and 50;
R^{VIII2} is OH or C₁-C₈-alkoxy; and
ρ is an integer between 0 and 5;
B.1.6 benzophenones, such as 2-hydroxy-4-methoxybenzophenone (Uvinul® 3040=Uvinul® M 40, BASF SE), 2-hydroxy-4-methoxy-4′-methylbenzophenone, 2,2′-dihydroxy-4-methoxybenzophenone, 2-(4-diethylamino-2-hydroxybenzoyl)-benzoic acid hexylester (Uvinul® A Plus, BASF SE), 2,4-dihydroxybenzo-phenone (Uvinul® 3000, BASF SE), 4-n-octyloxy-2-hydroxy-benzophenone (Uvinul® 3008, BASF SE), 2-hydroxybenophenone derivatives such as 4-hydroxy-2-hydroxybenzophenone, 4-methoxy-2-hydroxybenzophenone, 4-octyloxy-2-hydroxybenzophenone, 4-decyloxy-2-hydroxybenzophenone, 4-dodecyloxy-2-hydroxybenzophenone, 4-benzyloxy-2-hydroxy-benzophenone, 4,2′,4′-trihydroxy-2-hydroxybenzophenone, 2′-hydroxy-4,4′-dimethoxy-2-hydroxybenzophenone, 1,1′-(1,4-piperazinediyl)bis{1-[2-[4-(diethylamino)-2-hydroxybenzoyl]phenyl]}-methanone (CAS919803-06-8) and compounds of the formula IX

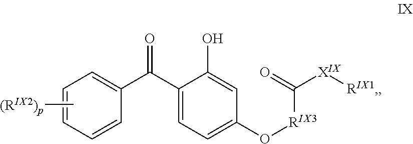

wherein
X^{IX} is NH or O;
R^{IX1} is H or [C₂-C₄-alkoxy]ₙ—(C₁-C₁₈-alkyl) or —[CH₂CH₂NH]ₙ—H,
   wherein n is an integer between 3 and 50;
R^{IX2} is OH or C₁-C₈-alkoxy;
ρ is an integer between 0 and 5; and
R^{IX3} is H or C₁-C₈-alkyl;
B.1.7 sulfonic acid derivatives of benzophenones, such as 2-hydroxy-4-methoxy-benzophenone-5-sulfonic acid (Uvinul® MS 40, BASF SE) and its salts, 2,2′-dihydroxy-4,4#-dimethoxybenzophenone-5,5′-sulfonic acid and its salts (di-sodium salt: Uvinul® DS 49, BASF SE);
B.1.8 3-benzylidenecamphor and derivatives thereof, such as 3-(4′-methylbenzyl-idene)d-1-camphor, benzylidiene camphor sulfonic acid (Mexoryl® SO, Chimex);
B.1.9 sulfonic acid derivatives of 3-benzylidenecamphor, such as 4-(2-oxo-3-bornyl-idenemethyl)benzenesulfonic acid and 2-methyl-5-(2-oxo-3-bornylidene)-sulfonic acid and salts thereof;
B.1.10 esters of benzalmalonic acid, such as 2-ethylhexyl 4-methoxybenzmalonate;
B.1.11 triazine derivatives, such as dioctylbutamidotriazone (Uvasorb® HEB, Sigma), 2,4,6-trinanilino-p-(carbo-2′-ethyl-hexyl-1′-oxy)-1,3,5-triazine (Uvinul® T 150, BASF SE), 2-[4-[(2-Hydroxy-3-(2′-ethyl)hexyl)oxy]-2-hydroxyphenyl]-4,6-bis-(2,4-dimethylphenyl)-1,3,5-triazine (Tinuvin® 405, CIBA AG), anisotriazine (Tinosorb® S, CIBA AG), 2,4,6-tris(diisobutyl 4′-aminobenzalmalonate)-s-triazine, 4,4′-{[6-(((tert.-butyl)aminocarbonyl)phenylamino)-1,3,5-triazin-2,4-diyl]imino}-bis(benzoic acid-2′-ethylhexylester), 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis-(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-Hydroxy-4-dodecyloxyphenyl)-4,6-bis(2,4-dimethylphenyl)-1,3,5-triazine, 2-[2-hydroxy-4-(2-hydroxy-3-butyloxypropyloxy)phenyl]-4,6-bis(2,4-dimethyl-phenyl)-1,3,5-triazine, 2-[2-hydroxy-4-(2-hydroxy-3-octyloxypropyloxy)phenyl]-4,6-bis-(2,4-di-methylphenyl)-1,3,5-triazine, 2-(2-hydroxy-4-tridecyloxyphenyl)-4,6-bis(2,4-dimethylphenyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-Hydroxy-4(2-hydroxy-3-dodecyloxypropoxy)phenyl]-4,6-bis-(2,4-dimethyl-phenyl)-1,3,5-triazine, 2-(2-Hydroxy-4-hexyloxyphenyl)-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxy-phenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl)-1,3,5-triazine, and compounds of the formula X

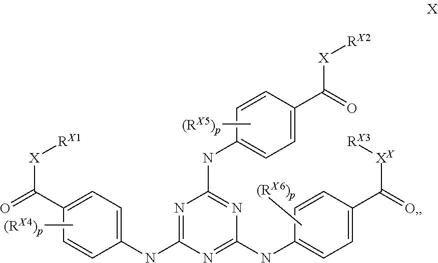

wherein
X^{X} is NH or O;
R^{X1}, R^{X2}, R^{X3} are independently of each other H, [C₂-C₄-alkoxy]ₙ—(C₁-C₁₈-alkyl) or —[CH₂CH₂NH]ₙ—H;
   wherein n is an integer between 3 and 50;
R^{X4}, R^{X5}, R^{X6} are independently of each other OH or C₁-C₈-alkoxy; and
ρ is an integer between 0 and 4; and
B.1.12 propane-1,3-diones, such as, 1-(4-tert-butylphenyl)-3-(4′-methoxyphenyl)propane-1,3-dione;
B.1.13 2-phenylbenzimidazole-5-sulfonic acid or 2-phenylbenzimidazole-4-sulfonic acid and alkali metal, alkaline earth metal, ammonium, alkylammonium, alkanolammonium and glucammonium salts thereof;
B.1.14 benzoylmethane derivatives, such as, 1-(4′-tert-butylphenyl)-3-(4′-methoxyphenyl)propane-1,3-dione, 4-tert-butyl-4′-methoxydibenzoylmethane or 1-phenyl-3-(4′-isopropylphenyl)propane-1,3-dione;
B.1.15 aminohydroxy-substituited derivatives of benzophenones, such as N,N-diethyl-aminohydroxybenzoyl-n-hexylbenzoate (Uvinul® A Plus B, BASF SE);
B.1.16 stilbene derivatives, such as di-sodium-di-styryl-biphenyldisulfonate (Uvitex®NFW, Ciba AG), 2,2′-(1E)-1,2-ethenediylbis[5-[[4-(methylamino)-6-[[4-[(methylamino)carbonyl]phenyl]amino]-1,3,5-triazin-2-yl]amino]-benzene sulfonic acid sodium salt (1:2, Tinosorb® FD, Ciba AG), 2,2′-[1,2-ethendiylbis[(3-sulfo-4,1-phenylen)imino-[6-(diethylamino)-1,3,5-triazine-4,2-diyl]imino]]bis-1,4-benzoldisulfonic acid hexa sodium salt (Tinopal® SFP, Ciba AG);
B.1.17 merocyanine derivatives, such as 5-(diethylamino)-2-(phenylsulfonyl)-2,4-pentadienoic acid octyl ester (CAS 98835-90-6, Fuji Photo Film Co., Ltd., Japan) or 2-cyano-2-[5,5-dimethyl-3-[(1-methylpropyl)amino]-2-cyclohexen-1-ylidene]-acetic acid ethyl ester (CAS1041630-38-9);
B.1.18 isoquinoline derivatives, such as 2-[2,6-bis(1-methylethyl)phenyl]-6-[4-(1,1,3,3-tetramethylbutyl)phenoxy]-1H-benz[de]isoquinoline-1,3(2H)-dione (CAS 852282-89-4, Uvinul® S Pack, BASF SE)
B.1.19 benzotropolone derivatives, such as 3,4,6-trihydroxy-5-oxo-5H-benzocycloheptene-8-carboxylic acid propyl ester (CAS1283016-28-3):
   and
B.1.20 mixtures of UV absorbers of groups B.1.1 to B.1.20, preferably of groups B.1.1 to B.1.16, such as a mixture of p-methoxycinnamic acid ethylhexyl ester (65%) and 2-(4-diethylamino-2-hydroxybenzoyl)benzoic acid hexylester (35%) (Uvinul® A Plus B, BASF SE).

Further suitable UV absorbers are to be found in the document “Cosmetic Legislation”, Vol. 1, Cosmetic Products, European Commission 1999, 64-66, and in lines 14 to 30 ([0030]) on page 6 of the document EP 1 191 041 A2, to both documents is referred to herewith.

Further examples for suitable UV absorbers are esters of 4,4-diphenylbutadien-1,1-dicarbon acids, such as bis(2-ethylhexyl)ester; derivatives of benzoxazoles; α-(2-oxoborn-3-ylidene)toluol-4-sulfonic acid or its salts, N,N,N-trimethyl-4-(2-oxoborn-3-ylidenmethyl)anilinium-monosulfate; and dibenzoylmethanes, such as 4-tert.-butyl-4′-methoxydibenzoylmethane.

The UV absorbers of groups B.1.1 to B.1.17 are known and are used in cosmetics, such as sunscreen, lipsticks or for stabilization of polymers such as plastics. Many of them are commercially available (such as Uvinul® products (BASF SE) or Tinuvin® products (CIBA AG) or may be found in EP 0 280 650; U.S. 61/160,124.

Inorganic UV filters (group B.2) are inorganic compounds which can reduce light intensity by absorbing, reflecting and scattering ultraviolet rays depending on the size of the particles and give off the absorbed energy again in the form of longer-wave radiation, e.g. heat. The term “Inorganic UV filters B.2” relates to one type or a mixture of different types of said compounds.

Examples for inorganic UV filters B.2, to which the present invention preferably relates, are selected from the group consisting of B.2.1 to B.2.4:

B.2.1 ZnO or inorganic absorbers based on ZnO (e.g. Z-Cote® products, BASF SE);

B.2.2 TiO₂ or inorganic absorbers based on TiO₂ (e.g. T-Lite™ products, BASF SE);

B.2.3 CeO₂ or inorganic absorbers based on CeO₂;
and

B.2.4 mixtures of inorganic UV filters of groups B.2.1 to B.2.3.

According to a preferred embodiment of the present invention, preference is given to inorganic UV filters selected from group B.2.2, especially preferred TiO₂.

Inorganic UV filters are known e.g. from “Sunlight, Vitamin D and Skin Cancer (J. Reichrath, Advances in experimental medicine and biology, Vol. 624, page 152, 2008).

“ROS detoxifying substances” (group B.3) are capable to detoxify reactive oxygen species (ROS) generated by light exposure in the green tissue, preferably under the influence of herbicides, more preferably under the influence of PPO-inhibiting herbicides. Thus “ROS detoxifying substances” can also be named as “reactive oxygen detoxifying substances”. The term “ROS detoxifying substances B.3” relates to one type or a mixture of different types of said compounds.

Examples for ROS detoxifying substances B.3, to which the present invention preferably relates, are selected from the group consisting of B.3.1 to B.3.30:
B.3.1 alkylated monophenoles such as 2,6-di-tert-butyl-4-methylphenol, 2-tert-butyl-4,6-dimethylphenol, 2,6-di-tert-butyl-4-ethylphenol, 2,6-di-tert-butyl-4-n-butyl-phenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methyl-phenol, 2,4,6-tricyclohexylphenol, 2,6-di-tert-butyl-4-methoxymethylphenol, linear or branched nonylphenols such as 2,6-di-nonyl-4-methylphenol, 2,4-dimethyl-6-(1-methylundec-1-yl)-phenol, 2,4-dimethyl-6-(1-methylheptadec-1-yl)-phenol, 2,4-dimethyl-6-(1-methyltridec-1-yl-)phenol and mixtures thereof;
B.3.2 alkylthiomethylphenols such as 2,4-dioctylthiomethyl-6-tert-butylphenol, 2,4-dioctylthiomethyl-6-methylphenol, 2,4-dioctylthiomethyl-6-ethylphenol and 2,6-didodecylthiomethyl-4-nonylphenol;
B.3.3 hydroquinones and alkylated hydroquinones such as 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenylstearate and bis-(3,5-di-tert-butyl-4-hydroxyphenyl)adipate;
B.3.4 tocopheroles, such as α-tocopherol, β-tocopherol, γ-tocopherol, δ-tocopherol and mixtures thereof (Vitamin E);
B.3.5 hydroxylated thiodiphenyl ethers such as 2,2′-thio-bis(6-tert-butyl-4-methyl-phenol), 2,2′-thio-bis(4-octylphenol), 4,4′-thio-bis(6-tert-butyl-3-methyl-phenol), 4,4′-thio-bis(6-tert-butyl-2-methylphenol), 4,4′-thio-bis-(3,6-di-sec-amylphenol) and 4,4′-bis(2,6-dimethyl-4-hydroxyphenyl)disulfide;
B.3.6 alkyliden-bisphenols such as 2,2′-methylen-bis(6-tert-butyl-4-methyl-phenol), 2,2′-methylen-bis(6-tert-butyl-4-ethylphenol), 2,2′-methylen-bis[4-methyl-6-α-methylcyclohexyl)-phenol], 2,2′-methylen-bis(4-methyl-6-cyclohexylphenol), 2,2′-Methylen-bis(6-nonyl-4-methylphenol), 2,2′-methylen-bis(4,6-di-tert-butyl-phenol), 2,2′-ethyliden-bis(4,6-di-tert-butylphenol), 2,2′-ethyliden-bis(6-tert-butyl-4-isobutylphenol), 2,2′-methylen-bis[6-(α-methylbenzyl)-4-nonylphenol], 2,2′-methylen-bis[6-(ag-dimethylbenzyl)-4-nonylphenol], 4,4′-methylen-bis(2,6-di-tert-butylphenol), 4,4′-methylen-bis(6-tert-butyl-2-methylphenol), 1,1-bis(5-tert-butyl-4-hydroxy-2-methylphenyl)-butane, 2,6-bis(3-tert-butyl-5-methyl-2-hydroxybenzyl)-4-methylphenol, 1,1,3-tris(5-tert-butyl-4-hydroxy-2-methyl-phenyl)butane, 1,1-bis(5-tert-butyl-4-hydroxy-2-methyl-phenyl)-3-n-dodecyl-mercaptobutane, ethylenglycol-bis-[3,3-bis(3-tert-butyl-4-hydroxyphenyl)-butyrate], bis(3-tert-butyl-4-hydroxy-5-methyl-phenyl)dicyclopentadiene, bis[2-(3′-tert-butyl-2-hydroxy-5-methylbenzyl)-6-tert-butyl-4-methyl-phenyl]-terephthalate, 1,1-bis-(3,5-dimethyl-2-hydroxyphenyl)butane, 2,2-bis-(3,5-di-tert-butyl-4-hydroxyphenyl)propane, 2,2-bis-(5-tert-butyl-4-hydroxy-2-methyl-phenyl)-4-n-dodecylmercaptobutane and 1,1,5,5-tetra-(5-tert-butyl-4-hydroxy-2-methylphenyl)-pentane;
B.3.7 benzylic compounds such as 3,5,3′,5′-tetra-tert-butyl-4,4′-dihydroxydibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxy-benzyl)amine, 1,3,5-tri-(3,5-di-tert-butyl-4-hydroxybenzyl)-2,4,6-trimethyl-benzene, di-(3,5-di-tert-butyl-4-hydroxybenzyl)sulfide, 3,5-di-tert-butyl-4-hydroxybenzyl-mercapto-essigsaureisooctylester, bis-(4-tert-butyl-3-hydroxy-2,6-dimethylbenzyl)dithiolterephthalate, 1,3,5-tris-(3,5-di-tert-butyl-4-hydroxy-benzyl)isocyanurate, 1,3,5-tris-(4-tert-butyl-3-hydroxy-2,6-dimethylbenzyl)-isocyanurate, 3,5-di-tert-butyl-4-hydroxybenzyl-phosphorsauredioctadecylester and 3,5-di-tert-butyl-4-hydroxybenzyl-phosphorsauremonoethyl ester as well as its calcium salt;
B.3.8 hydroxybenzylated malonates such as dioctadecyl-2,2-bis-(3,5-di-tert butyl-2-hydroxybenzyl)-malonate, di-octadecyl-2-(3-tert-butyl-4-hydroxy-5-methyl-benzyl)-malonate, di-dodecylmercaptoethyl-2,2-bis-(3,5-di-tert-butyl-4-hydroxy-benzyl)malonate and bis[4-(1,1,3,3-tetramethylbutyl)phenyl]-2,2-bis(3,5-di-tert-butyl-4-hydroxybenzyl)malonate;
B.3.9 hydroxybenzylic aromates such as 1,3,5-tris-(3,5-di-tert-butyl-4-hydroxy-benzyl)-2,4,6-trimethylbenzene, 1,4-bis(3,5-di-tert-butyl-4-hydroxybenzyl)-2,3,5,6-tetramethylbenzene and 2,4,6-tris(3,5-di-tert-butyl-4-hydroxybenzyl)-phenol;
B.3.10 triazin compounds such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-di-tert-butyl-4-hydroxybenzyl)isocyanurate, 1,3,5-tris(4-tert-butyl-3-hydroxy-2,6-dimethylbenzyl)isocyan u rate, 2,4,6-tris(3,5-di-tert-butyl-4-hydroxyphenylethyl)-1,3,5-triazine, 1,3,5-tris(3,5-di-tert-butyl-4-hydroxyphenylpropionyl)-hexahydro-1,3,5-triazine and 1,3,5-tris(3,5-dicyclo-hexyl-4-hydroxybenzyl)-isocyanurate;
B.3.11 benzylphosphonates such as dimethyl-2,5-di-tert-butyl-4-hydroxybenzyl-phosphonate, diethyl-3,5-di-tert-butyl-4-hydroxybenzylphosphonate, ((3,5-bis(1,1-dimethylethyl)-4-hydroxyphenyl)methyl)lphosphonic acid diethylester), dioctadecyl-3,5-di-tert-butyl-4-hydroxybenzylphosphonate, dioctadecyl-5-tert-butyl-4-hydroxy-3-methylbenzylphosphonate and the calcium salt of 3,5-di-tert-butyl-4-hydroxybenzylphosphonic acid monoethylester;
B.3.12 acylaminophenols such as 4-hydroxy-laurinsäureanilide, 4-hydroxystearinacid anilide, 2,4-bis-octylmercapto-6-(3,5-tert-butyl-4-hydroxyanilino)-s-triazine and octyl-N-(3,5-di-tert-butyl-4-hydroxyphenyl)-carbamate;
B.3.13 esters of β-(3,5-di-tert-butyl-4-hydroxyphenyl)propionic acid with mono or multivalent alcohols such as methanol, ethanol, n-octanol, i-octanol, octadecanol, 1,6-hexanediol, 1,9-nonanediol, ethylenglycol, 1,2-propanediol, neopentylglycol, thiodiethylenglycole, diethyleneglycol, triethyleneglycol, pentaerythrole, tris(hydroxyethyl)isocyanurate, N,N′-bis-(hydroxyethyl)oxalic acid diamid, 3-thiaundecanol, 3-thiapentadecanol, trimethylhexanediol, trimethylolpropane and 4-hydroxymethyl-1-phospha-2,6,7-trioxabicyclo[2.2.2]octane;
B.3.14 esters of β-(5-tert-butyl-4-hydroxy-3-methylphenyl)propionic acid with mono or multivalent alcohols, such as methanol, ethanol, n-octanol, i-octanol, octadecanol, 1,6-hexanediol, 1,9-nonanediol, ethylenglycol, 1,2-propanediol, neopentylglycol, thiodiethylenglycole, diethyleneglycol, triethyleneglycol, pentaerythrole, tris(hydroxyethyl)-isocyanurate, N,N′-bis-(hydroxyethyl)oxalic acid diamid, 3-thiaundecanol, 3-thiapentadecanol, trimethylhexanediol, trimethylolpropane and 4-hydroxymethyl-1-phospha-2,6,7-trioxabicyclo[2.2.2]octane;
B.3.15 esters of β-(3,5-dicyclohexyl-4-hydroxyphenyl)propionic acid with mono or multivalent alcohols, such as methanol, ethanol, n-octanol, i-octanol, octadecanol, 1,6-hexanediol, 1,9-nonanediol, ethylenglycol, 1,2-propanediol, neopentylglycol, thiodiethylenglycole, diethyleneglycol, triethyleneglycol, pentaerythrole, tris(hydroxyethyl)-isocyanurate, N,N′-bis-(hydroxyethyl)oxalic acid diamid, 3-thiaundecanol, 3-thiapentadecanol, trimethylhexanediol, trimethylolpropane and 4-hydroxymethyl-1-phospha-2,6,7-trioxabicyclo[2.2.2]octane;
B.3.16 esters of 3,5-di-tert-butyl-4-hydroxyphenylacetic acid with mono or multivalent alcohols, such as methanol, ethanol, n-octanol, i-octanol, octadecanol, 1,6-hexanediol, 1,9-nonanediol, ethylenglycol, 1,2-propanediol, neopentylglycol, thiodiethylenglycole, diethyleneglycol, triethyleneglycol, pentaerythrole, tris(hydroxyethyl)-isocyanurate, N,N′-bis-(hydroxyethyl)oxalic acid diamid, 3-thiaundecanol, 3-thiapentadecanol, trimethylhexanediol, trimethylolpropane and 4-hydroxymethyl-1-phospha-2,6,7-trioxabicyclo[2.2.2]octane;
B.3.17 amides of β-(3,5-di-tert-butyl-4-hydroxyphenyl)propionic acid such as N,N′-bis-(3,5-di-tert-butyl-4-hydroxyphenylpropionyl)-hexamethylendiamide, N,N′-bis-(3,5-di-tert-butyl-4-hydroxyphenylpropionyl)-trimethylendiamide, N,N′-bis(3,5-di-tert-butyl-4-hydroxyphenylpropionyl)-hydrazide and N,N′-bis[2-(3-[3,5-di-tert-butyl-4-hydroxyphenyl]-propionyloxy)ethyl]-oxamide (e.g. Naugard®XL-1, Uniroyal);
B.3.18 ascorbic acid (Vitamin C);
B.3.19 aminic antioxidants, such as N,N′-di-isopropyl-p-phenylendiamine, N,N′-di-sec-butyl-p-phenylendiamine, N,N′-bis(1,4-dimethylpentyl)-p-phenylendiamine, N,N′-bis(1-ethyl-3-methylpentyl)-p-phenylendiamine, N,N′-bis(1-methylheptyl)-p-phenylendiamine, N,N′-dicyclohexyl-p-phenylendiamine, N,N′-diphenyl-p-phenylendiamine, N,N′-bis(2-naphthyl)-p-phenylendiamine, N-isopropyl-N′-phenyl-p-phenylendiamine, N-(1,3-dimethylbutyl)-N′-phenyl-p-phenylen-diamine, N-(1-methylheptyl)-N′-phenyl-p-phenylendiamine, N-cyclohexyl-N′-phenyl-p-phenylendiamine, 4-(p-toluolsulfamoyl)diphenylamine, N,N′-dimethyl-N,N′-di-sec-butyl-p-phenylendiamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamines, such as p,p′-di-tert-octyldiphenylamine, 4-n-butylaminophenol, 4-butyrylaminophenol, 4-nonanoylaminophenol, 4-dodecanoylaminophenol, 4-octadecanoylamino-phenol, bis-(4-methoxyphenyl)amine, 2,6-di-tert-butyl-4-dimethylaminomethyl-phenol, 2,4′-diaminodiphenylmethane, 4,4′-diaminodiphenylmethan, N,N,N′,N′-tetramethyl-4,4′-diaminodiphenylmethan, 1,2-bis-[(2-methylphenyl)amino]-ethane, 1,2-bis(phenylamino)-propane, (o-tolyl)-biguanide, bis[4-(1′,3′-dimethyl-butyl)phenyl]amine, tert-octylated N-phenyl-1-naphthylamin, mixture of mono- and dialkylated tert-butyl/tert-octyldiphenylamines, mixtures of mono- and dialkylated nonyldiphenylamines, mixtures of mono- and dialkylated dodecyldiphenylamines, mixtures of mono- and dialkylated isopropyl/lsohexyldiphenyl-amines, mixtures of mono- and dialkylated tert-butyldiphenylamines, 2,3-di-hydro-3,3-dimethyl-4H-1,4-benzothiazin, phenothiazine, mixtures of mono- and dialkylated tert-butyl/tert-octyl-phenothiazines, mixtures of mono- and dialkylated tert-octyl-phenothiazines, N-allylphenothiazine, N,N,N′,N′-tetraphenyl-1,4-diaminobut-2-ene, N,N-bis-(2,2,6,6-tetramethyl-piperidin-4-yl-hexamethylene-diamine, 2,2,6,6-tetramethylpiperidin-4-one, 2,2,6,6 tetramethylpiperidin-4-ol, dimethylsuccinat-polymer with 4-hydroxy-2,2,6,6-tetramethyl-1-piperidinethanol (CAS Nummer 65447-77-0, such as Tinuvin® 622, Ciba Specialty Chemicals, Inc.) and polymer of 2,2,4,4-tetramethyl-7-oxa-3,20-diaza-dispiro[5.1.11.2]-heeicosan-21-on and epichloorhydrine (CAS-No.: 202483-55-4 such as Hostavin® N 30, Clariant);
B.3.20 sterical hindered amines, such as 4-hydroxy-2,2,6,6-tetramethylpiperidin, 1-allyl-4-hydroxy-2,2,6,6-tetramethylpiperidin, 1-benzyl-4-hydroxy-2,2,6,6-tetramethylpiperidin, bis(2,2,6,6-tetramethyl-4-piperidyl)sebacate, bis(2,2,6,6-tetramethyl-4-piperidyl)succinate, bis(1,2,2,6,6-pentamethyl-4-piperidyl)-sebacate, bis(1-octyloxy-2,2,6,6-tetramethyl-4-piperidyl)sebacate, bis-(1,2,2,6,6-pentamethyl-4-piperidyl)-n-butyl-3,5-di-tert-butyl-4-hydroxybenzyl-malonate (n-butyl-3,5-di-tert-butyl-4-hydroxy-benzyl-malonic acid-bis(1,2,2,6,6-pentamethylpiperidyl)-ester), condensation product of 1-(2-hydroxyethyl)-2,2,6,6-tetramethyl-4-hydroxypiperidin and succinic acid, linear or cyclic condensation products of N,N′ bBis(2,2,6,6-tetramethyl-4-piperidyl)hexamethylendiamine and 4-tert-octylamino-2,6-dichlor-1,3,5-triazine, tris(2,2,6,6-tetra-methyl-4-piperidyl)-nitrilotriacetate, tetrakis(2,2,6,6-tetramethyl-4-piperidyl)-1,2,3,4-butan-tetracarboxylate, 1,1′-(1,2-ethandiyl)-bis(3,3,5,5-tetramethyl-piperazinone), 4-benzoyl-2,2,6,6-tetramethylpiperidine, 4-stearyloxy-2,2,6,6-tetramethylpiperidine, bis-(1,2,2,6,6-pentamethylpiperidyl)-2-n-butyl-2-(2-hydroxy-3,5-di-tert butylbenzyl)malonate, 3-n-octyl-7,7,9,9-tetramethyl-1,3,8-triazaspiro[4.5]decan-2,4-dione, bis-(1-octyloxy-2,2,6,6-tetramethylpiperidyl)-sebacate, bis-(1-octyloxy-2,2,6,6-tetramethyl-piperidyl)-succinate, linear or cyclic condensation products of N,N′-bis-(2,2,6,6-tetramethyl-4-piperidyl)hexamethylendiamine and 4-morpholino-2,6-dichlor-1,3,5-triazine, condensation product of 2-chlor-4,6-bis(4-n-butylamino-2,2,6,6-tetramethylpiperidyl)-1,3,5-triazine and 1,2-bis(3-aminopropylamino)ethane, condensation product of 2-chlor-4,6-di-(4-n-butylamino-1,2,2,6,6-pentamethylpiperidyl)-1,3,5-triazine and 1,2-bis-(3-aminopropylamino)ethan, 8-acetyl-3-dodecyl-7,7,9,9-tetramethyl-1,3,8-triazaspiro[4.5]decan-2,4-dione, 3-dodecyl-1-(2,2,6,6-tetramethyl-4-piperidyl)pyrrolidin-2,5-dion, 3-dodecyl-1-(1,2,2,6,6-pentamethyl-4-piperidyl)-pyrrolidin-2,5-dione, mixture of 4-hexadecyloxy-und 4-stearyloxy-2,2,6,6-tetramethylpiperidine, condensation product of N,N′-bis(2,2,6,6-tetramethyl-4-piperidyl)hexamethylendiamine and 4-cyclohexylamino-2,6-dichlor-1,3,5-triazine, condensation product of 1,2-bis(3-aminopropylamino)ethane, 2,4,6-trichlor-1,3,5-triazine and 4-butylamino-2,2,6,6-tetramethylpiperidine (CAS No. 136504-96-6), N-(2,2,6,6-tetramethyl-4-piperidyl)-n-dodecylsuccinimide, N-(1,2,2,6,6-pentamethyl-4-piperidyl)-n-dodecylsuccinimide, 2-undecyl-7,7,9,9-tetramethyl-1-oxa-3,8-diaza-4-oxospiro[4, 5]decane, reaction product of 7,7,9,9-tetramethyl-2-cycloundecyl-1-oxa-3,8-diaza-4-oxospiro[4, 5]decan and epichlorhydrin, 1,1-bis(1,2,2,6,6-pentamethyl-4-piperidyloxycarbonyl)-2-(4-methoxyphenyl)ethene, diester of 4-methoxy-methylen-malonic acid with 1,2,2,6,6-pentamethyl-4-hydroxypiperidine, poly[methylpropyl-3-oxo-4-(2,2,6,6-tetramethyl-4-piperidyl)]siloxane, 1-(2-hydroxy-2-methylpropoxy)-4-octadecanoyloxy-2,2,6,6-tetramethylpiperidine, 1-(2-hydroxy-2-methylpropoxy)-4-hexadecanoyloxy-2,2,6,6-tetramethylpiperidine, reaction product of 1-oxy]-4-hydroxy-2,2,6,6-tetramethylpiperidin and t-amylalcohol, 1-(2-hydroxy-2-methyl-propoxy)-4-hydroxy-2,2,6,6-tetramethylpiperidine, 1-(2-hydroxy-2-methylpropoxy)-4-oxo-2,2,6,6-tetramethylpiperidine, bis(1-(2-hydroxy-2-methylpropoxy)-2,2,6,6-tetramethylpiperidin-4-yl)sebacate, bis(1-(2-hydroxy-2-methylpropoxy)-2,2,6,6-tetramethylpiperidin-4-yl)adipate, Bis(1-(2-hydroxy-2-methylpropoxy)-2,2,6,6-tetramethylpiperidin-4-yl)succinate, bis(1-(2-hydroxy-2-methylpropoxy)-2,2,6,6-tetramethylpiperidin-4-yl)glutarate, 2,4-bis{N[1-(2-hydroxy-2-methylpropoxy)-2,2,6,6-tetramethylpiperidin-4-yl]-N-butylamino}-6-(2-hydroxy-ethylamino)-s-triazine, hexahydro-2,6-bis(2,2,6,6-tetramethyl-4-piperidyl)-1H, 4H, 5H, 8H-2,3a,4a,6,7a,8a-hexaazacyclopenta[def]fluoren-4,8-dione (Uvinul® 4049, BASF SE), poly[[6-[(1,1,3,3-tetramethylbutyl)amino]-1,3,5-triazin-2,4-diyl][(2,2,6,6-tetramethyl-4-piperidinyl)imino]1,6-hexandiyl[(2,2,6,6-tetramethyl-4-piperidinyl)imino]]) (CAS Nr. 71878-19-8), and 1,3,5-triazin-2,4,6-triamin,N,N′″-[1,2-ethan-diyl-bis[[4,6-bis-[butyl(1,2,2,6,6-pentamethyl-4-piperidinyl)amino]-1,3,5-triazin-2-yl]imino]-3,1-propandiyl]]bis[N′,N″-dibutyl-N′,N″-bis(1,2,2,6,6-pentamethyl-4-piperidinyl) (CAS Nr. 106990-43-6, Chimassorb® 119, Ciba Specialty Chemicals, Inc.);
B.3.21 phosphites and phosphonites such as triphenylphosphite, diphenylalkylphosphite, phenyldialkylphosphite, tris(nonylphenyl)phosphite, trilaurylphosphite, trioctadecylphosphite, distearylpentaerythritdiphosphite, tris(2,4-di-tert-butyl-phenyl)phosphite, diisodecylpentaerythritdiphosphite, bis(2,4-di-tert-butyl-phenyl)pentaerythritdiphosphite, bis(2,6-di-tert-butyl-4-methylphenyl)-pentaerythritdiphosphite, diisodecyloxypentaerythritdiphosphite, bis(2,4-di-tert-butyl-6-methylphenyl)pentaerythritdiphosphite, bis(2,4,6-tris(tert-butylphenyl)pentaerythritdiphosphite, tristearylsorbittriphosphite, tetrakis-(2,4-di-tert-butylphenyl)-4,4′-biphenylendiphosphonite, 6-isooctyloxy-2,4,8,10-tetra-tert-butyl-dibenz-[d,f][1,3,2]dioxaphosphepin, 6-fluor-2,4,8,10-tetra-tert-butyl-[2-methyl-dibenz-[d,g][1,3,2]dioxaphosphocin, bis(2,4-di-tert-butyl-6-methylphenyl)methyl-phosphite, bis(2,4-di-tert-butyl-6-methylphenyl)ethylphosphite, 2,2′,2″-nitrilo-[triethyl-tris(3,3′,5,5′-tetra-tert-butyl-1,1′-biphenyl-2,2′-diyl)phosphite] and 2-ethylhexyl-(3,3′,5,5′-tetra-tert-butyl-1,1′-biphenyl-2,2′-diyl)phosphate;
B.3.22 hydroxylamines such as N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octadecylhydroxylamine and N-methyl-N-octadecylhydroxylamine;
B.3.23 aminoxides such as derivates describes in U.S. Pat. No. 5,844,029 and U.S. Pat. No. 5,880,191 as well as didecylmethylaminoxide, tridecylaminoxide, tridodecylaminoxide and trihexadecylaminoxid;
B.3.24 benzofuranones and indolinones as describes in U.S. Pat. No. 4,325,863; U.S. Pat. No. 4,338,244; U.S. Pat. No. 5,175,312; U.S. Pat. No. 5,216,052; U.S. Pat. No. 5,252,643; DE-A-4316611; DE-A-4316622; DE-A-4316876, EP-A-0589839 and EP-A-0591102; as well as e.g. 3-[4-(2-acetoxyethoxy)phenyl]-5,7-di-tert-butyl-benzofuran-2-on, 5,7-di-tert-butyl-3-[4-(2-stearoyloxyethoxy)phenyl]benzofuran-2-on, 3,3′-bis[5,7-di-tert-butyl-3-(4-[2-hydroxyethoxy]phenyl)benzofuran-2-on], 5,7-di-tert-butyl-3-(4-ethoxyphenyl)-benzofuran-2-on, 3-(4-acetoxy-3,5-dimethylphenyl)-5,7-di-tert-butyl-benzofuran-2-on, 3-(3,5-dimethyl-4-pivaloyloxyphenyl)-5,7-di-tert-butyl-benzofuran-2-on, 3-(3,4-dimethylphenyl)-5,7-di-tert-butyl-benzofuran-2-on (Irganox® HP-136; Ciba Specialty Chemicals), and 3-(2,3-dimethylphenyl)-5,7-di-tert-butyl-benzofuran-2-on;
B.3.25 peroxide decomposing compounds such as esters of β-thiodipropionic acid, e.g. lauryl-, stearyl-, myristyl- or tridecylester, mercaptobenzimidazole or the zinc salt of 2-mercaptobenzimidazol, zincdibutyldithiocarbamate, dioctadecyl-disulfide and pentaerythrit-tetrakis(β-dodecylmercapto)propionate;
B.3.26 carotenoids such as lycopene, β-carotene, lycopersene (7,8,11,12,15,7′,8′,11′,12′,15′-decahydro-γ,γ-carotene), phytofluene (hexahydrolycopene 15-cis-7,8,11,12,7′,8′-Hexahydro-γ,γ-carotene), torulene (3′,4′-didehydro-β,γ-carotene), α-zeacarotene (7′,8′-dihydro-ε,γ-carotene), alloxanthin, cynthiaxanthin, pectenoxanthin, cryptomonaxanthin[(3R,3′R)-7,8,7′,8′-tetradehydro-β,β-carotene-3,3′-diol], crustaxanthin (β,γ-carotene-3,4,3′,4′-tetrol), gazaniaxanthin [(3R)-5′-cis-β,γ-caroten-3-ol], OH-chlorobactene (1′,2′-dihydro-f,γ-caroten-1′-ol), loroxanthin (β,ε-carotene-3,19, 3′-triol), lycoxanthin (γ,γ-caroten-16-ol), rhodopin (1,2-dihydro-γ,γ-caroten-1-ol), rhodopinol, warmingol (13-cis-1,2-dihydro-γ,γ-carotene-1,20-diol), saproxanthin (3′,4′-didehydro-1′,2′-dihydro-β,γ-carotene-3,1′-diol), oscillaxanthin (2,2′-bis(β-L-rhamnopyranosyloxy)-3,4,3′,4′-tetradehydro-1,2,1′,2′-tetrahydro-γ,γ-carotene-1,1′-diol), phleixanthophyll (1′-(β-D-glucopyranosyloxy)-3′,4′-didehydro-1′,2′-dihydro-β,γ-caroten-2′-ol), rhodovibrin (1′-methoxy-3′,4′-didehydro-1,2,1′,2′-tetrahydro-γ,γ-caroten-1-ol), spheroidene (1-methoxy-3,4-didehydro-1,2,7′,8′-tetrahydro-γ,γ-carotene), diadinoxanthin (5,6-epoxy-7′,8′-didehydro-5,6-dihydro-carotene-3,3-diol), luteoxanthin (5,6: 5′,8′-diepoxy-5,6,5′,8′-tetrahydro-β,β-carotene-3,3′-diol), mutatoxanthin, citroxanthin, zeaxanthin (furanoxide 5,8-epoxy-5,8-dihydro-β,β-carotene-3,3′-diol), neochrome (5′,8′-epoxy-6,7-didehydro-5,6,5′,8′-tetrahydro-β,β-carotene-3,5,3′-triol), foliachrome, trollichrome, vaucheriaxanthin (5′,6′-epoxy-6,7-didehydro-5,6,5′,6′-tetrahydro-β,β-carotene-3,5,19,3′-tetrol), rhodopinal, wamingone (13-cis-1-Hydroxy-1,2-dihydro-γ,γ-caroten-20-al), torularhodinaldehyde (3′,4′-didehydro-β,γ-caroten-16′-al), torularhodin (3′,4′-didehydro-β,γ-caroten-16′-oic acid), torularhodin methyl ester, canthaxanthin, chlorellaxanthin (β,β-carotene-4,4′-dione), capsanthin[(3R,3′S,5′R)-3,3′-dihydroxy-β,κ-caroten-6′-one], capsorubin[(3S,5R,3′S,5′R)-3,3′-dihydroxy-κ,κ-carotene-6,6′-dione], cryptocapsin[(3′R,5′R)-3′-hydroxy-β,κ-caroten-6′-one], 2,2′-diketospirilloxanthin (1,1′-dimethoxy-3,4,3′,4′-tetradehydro-1,2,1′,2′-tetrahydro-γ,γ-carotene-2,2′-dione), flexixanthin (3,1′-dihydroxy-3′,4′-didehydro-1′,2′-dihydro-β,γ-caroten-4-one), 3-OH-canthaxanthin (3-hydroxy-β,β-carotene-4,4′-dione), hydroxyspheriodenone (1′-hydroxy-1-methoxy-3,4-didehydro-1,2,1′,2′,7′,8′-hexahydro-γ,γ-caroten-2-one), okenone (1′-methoxy-1′,2′-dihydro-c,γ-caroten-4′-one), pectenolone (3,3′-dihydroxy-7′,8′-didehydro-β,β-caroten-4-one), phoeniconone (3-hydroxy-2,3-didehydro-β,β-carotene-4,4′-dione), phoenicopterone (β,ε-caroten-4-one), rubixanthone (3-hydroxy-β,γ-caroten-4′-one), siphonaxanthin (3,19,3′-trihydroxy-7,8-dihydro-β,ε-caroten-8-one), astacein (3,3′-bispalmitoyloxy-2,3,2′,3′-tetradehydro-β,β-carotene-4,4′-dione or 3,3′-dihydroxy-2,3,2′,3′-tetradehydro-β,β-carotene-4,4′-dione dipalmitate), fucoxanthin (3′-acetoxy-5,6-epoxy-3,5′-dihydroxy-6′,7′-didehydro-5,6,7,8,5′,6′-hexahydro-β,β-caroten-8-one), isofucoxanthin (3′-acetoxy-3,5,5′-trihydroxy-6′,7′-didehydro-5,8,5′,6′-tetrahydro-β,β-caroten-8-one), zeaxanthin dipalmitate [(3R,3′R)-3,3′-bispalmitoyloxy-β,β-carotene or (3R,3′R)-β,β-carotene-3,3′-diol dipalmitate], siphonein (3,3′-dihydroxy-19-lauroyloxy-7,8-dihydro-β,ε-caroten-8-one or 3,19,3′-trihydroxy-7,8-dihydro-β,ε-caroten-8-one 19-laurate), β-apo-2′-carotenal (3′,4′-didehydro-2′-apo-b-caroten-2′-al), apo-2-lycopenal, apo-6′-lycopenal, 6′-apo-y-caroten-6′-al, azafrinaldehyde (5,6-dihydroxy-5,6-dihydro-10′-apo-β-caroten-10′-al), bixin (6′-methyl hydrogen 9′-cis-6,6′-diapocarotene-6,6′-dioate), citranaxanthin (5′,6′-dihydro-5′-apo-β-caroten-6′-one or 5′,6′-dihydro-5′-apo-18′-nor-β-caroten-6′-one or 6′-methyl-6′-apo-β-caroten-6′-one), crocetin (,8′-diapo-8,8′-carotenedioic acid), crocetinsemialdehyde (8′-oxo-8,8′-diapo-8-carotenoic acid), crocin (digentiobiosyl 8,8′-diapo-8,8′-carotenedioate), hopkinsiaxanthin, methyl apo-6′-lycopenoate, methyl 6′-apo-y-caroten-6′-oate, paracentrone, sintaxanthin, actinioerythrin (3,3′-bisacyloxy-2,2′-dinor-b,b-carotene-4,4′-dione), β-carotenone (5, 6:5′,6′-diseco-b,b-carotene-5,6,5′,6′-tetrone), peridinin (3′-acetoxy-5,6-epoxy-3,5′-dihydroxy-6′,7′-didehydro-5,6,5′,6′-tetrahydro-12′,13′,20′-trinor-b,b-caroten-19,11-olide), pyrrhoxanthininol (5,6-epoxy-3,3′-dihydroxy-7′,8′-didehydro-5,6-dihydro-12′,13′,20′-trinor-b,b-caroten-19,11-olide), semi-α-carotenone (5,6-seco-b,e-carotene-5,6-dione), semi-β-carotenone (5,6-seco-b,b-carotene-5,6-dione or 5′,6′-seco-b,b-carotene-5′,6′-dione) and triphasiaxanthin;
B.3.27 flavanoids such as luteolin, apigenin, tangeritin, quercetin, kaempferol, myricetin, fisetin, isorhamnetin, pachypodol, rhamnazin, hesperetin, naringenin, eriodictyol, homoeriodictyol, taxifolin (or dihydroquercetin), dihydrokaempferol, catechins [e.g. catechin (C), gallocatechin (GC), catechin 3-gallate (Cg), gallocatechin 3-gallate (GCg)], epicatechins [e.g. epicatechin (EC), epigallocatechin (EGC), epicatechin 3-gallate (ECg), epigallocatechin 3-gallate (EGCg), cyanidin, delphinidin, malvidin, pelargonidin, peonidin, petunidin and resveratrol (trans-3,4′,5-trihydroxystilbene);
B.3.28 activators of the antioxidative system such as abscisic acid (ABA; 2-cis,4-trans,1′S)-5-(1-hydroxy-2,6,6-trimethyl-4-oxo-2-cyclohexen-1-yl)-3-methyl-2,4-pentadiene acid);
B.3.29 aromatic hydroxylated carbonic acid and their esters such as salicylic acid (2-hydroxybenzoic acid), methyl-2-hydroxybenzoate, ethyl-2-hydroxybenzoate, n-propyl-2-hydroxybenzoate, iso-propyl-2-hydroxybenzoate, n-butyl-2-hydroxy-benzoate, sec-butyl-2-hydroxybenzoate, iso-butyl-2-hydroxybenzoate, tert-butyl-2-hydroxybenzoate, 4-hydroxybenzoic acid, methyl-4-hydroxy-benzoate, ethyl-4-hydroxybenzoate, n-propyl-4-hydroxybenzoate, iso-propyl-4-hydroxy-benzoate, n-butyl-4-hydroxybenzoate, sec-butyl-4-hydroxybenzoate, iso-butyl-4-hydroxybenzoate, tert-butyl-4-hydroxybenzoate, 3,4-dihydroxybenzoic acid, methyl-3,4-dihydroxybenzoate, ethyl-3,4-dihydroxybenzoate, n-propyl-3,4-dihydroxybenzoate, i-propyl-3,4-dihydroxybenzoate, n-butyl-3,4-dihydroxy-benzoate, sec-butyl-3,4-dihydroxybenzoate, iso-butyl-3,4-dihydroxy-benzoate, tert-butyl-3,4-dihydroxybenzoate, 2,5-dihydroxybenzoic acid, methyl-2,5-dihydroxybenzoate, ethyl-2,5-dihydroxybenzoate, n-propyl-2,5-dihydroxy-benzoate, iso-propyl-2,5-dihydroxybenzoate, n-butyl-2,5-dihydroxy-benzoate, sec-butyl-2,5-dihydroxybenzoate, iso-butyl-2,5-dihydroxybenzoate, tert-butyl-2,5-dihydroxybenzoate, 3,5-dihydroxybenzoic acid, methyl-3,5-dihydroxy-benzoate, ethyl-3,5-dihydroxybenzoate, n-propyl-3,5-dihydroxybenzoate, isopropyl-3,5-dihydroxybenzoate, n-butyl-3,5-dihydroxybenzoate, sec-butyl-3,5-dihydroxybenzoate, iso-butyl-3,5-dihydroxybenzoate, tert-butyl-3,5-dihydroxy-benzoate, gallic acid (3,4,5-trihydroxybenzoate), methylgallate, ethylgallate, n-propylgallate (n-propyl-3,4,5-trihydroxybenzoate), iso-propylgallate (iso-propyl-3,4,5-trihydroxybenzoate), n-butylgallate, sec-butylgallate, iso-butylgallate, tert-butylgallate;
preferably aromatic hydroxylated carbonic acid and their esters selected from as 4-hydroxybenzoic acid, methyl-4-hydroxybenzoate, ethyl-4-hydroxy-benzoate, n-propyl-4-hydroxybenzoate, iso-propyl-4-hydroxybenzoate, n-butyl-4-hydroxybenzoate, sec-butyl-4-hydroxybenzoate, iso-butyl-4-hydroxy-benzoate, tert-butyl-4-hydroxybenzoate, 3,4-dihydroxybenzoic acid, methyl-3,4-dihydroxybenzoate, ethyl-3,4-dihydroxybenzoate, n-propyl-3,4-dihydroxy-benzoate, i-propyl-3,4-dihydroxybenzoate, n-butyl-3,4-dihydroxybenzoate, sec-butyl-3,4-dihydroxybenzoate, iso-butyl-3,4-dihydroxybenzoate, tert-butyl-3,4-dihydroxybenzoate, 2,5-dihydroxybenzoic acid, methyl-2,5-dihydroxy-benzoate, ethyl-2,5-dihydroxybenzoate, n-propyl-2,5-dihydroxybenzoate, iso-propyl-2,5-dihydroxybenzoate, n-butyl-2,5-dihydroxybenzoate, sec-butyl-2,5-dihydroxy-benzoate, iso-butyl-2,5-dihydroxybenzoate, tert-butyl-2,5-dihydroxy-benzoate, 3,5-dihydroxybenzoic acid, methyl-3,5-dihydroxybenzoate, ethyl-3,5-dihydroxy-benzoate, n-propyl-3,5-dihydroxybenzoate, iso-propyl-3,5-dihydroxy-benzoate, n-butyl-3,5-dihydroxybenzoate, sec-butyl-3,5-dihydroxybenzoate, iso-butyl-3,5-dihydroxybenzoate, tert-butyl-3,5-dihydroxybenzoate, gallic acid (3,4,5-trihydroxybenzoate), methylgallate, ethylgallate, n-propylgallate (n-propyl-3,4,5-trihydroxybenzoate), iso-propylgallate (iso-propyl-3,4,5-trihydroxybenzoate), n-butylgallate, sec-butylgallate, iso-butylgallate, tert-butylgallate;

and
B.3.30 mixtures of ROS detoxifying substances of groups B.3.1 to B.3.29.

ROS detoxifying substances are known for example from Beutner et al., J. Sci. Food Agric. 2001, 81, 559; Moggia et al, Spanish Journal of Agricultural Research 2010, 8, 178-187; S. Fujisawa et al., SAR and QSAR in Environmental Research 2002, 13, 617-627; K. Tang et al., J. of Plant Physiol. 2010, 167, 95-102; F. J. Berli et al., Plant, Cell and Environment 2010, 33, 1-10; C. Triantaphylides et al., Trends in Plant Science 2009, 14, 219-228.

According to one embodiment of the present invention, the light detoxifying compound B is selected from the group consisting of B.1, B.2 and B.3;

preferably selected from the group consisting of B.1 and B.2;

more preferably selected from B.1;

especially preferably selected from the group consisting of B.1.2 and B.1.6;

most preferably selected from Uvinul® 3035, Uvinul® N 539, Uvinul® 3035 ethoxylated with Pluriol A 3050 E, Uvinul® A Plus, Uvinul® 3000, Uvinul® 3040 and Uvinul® 3040 ethoxylated with Pluriol A 3050 E.

According to another embodiment of the present invention, the light detoxifying compound B is preferably selected from the group consisting of B.2 and B.3; preferably selected from B.2;

more preferably selected from B.2.2;

especially preferably selected from TiO₂.

According to another embodiment of the present invention, the light detoxifying cornpound B is preferably selected from the group consisting of B.1 and B.3;

preferably B.3;

more preferably selected from the group consisting of B.3.4, B.3.19, B.3.27, B.3.28 and B.3.29;

especially preferably selected from a-tocopherol, diphenylamine, resveratrol, abscisic acid and n-propylgallate;

most preferably selected from diphenylamine and n-propylgallate.

According to another embodiment of the present invention, the light detoxifying compound B is preferably selected from the group consisting of B1.2, B.1.6, B.2.2, B.3.4, B.3.19, B.3.27, B.3.28 and B.3.29;

more preferably selected from the group consisting of Uvinul® 3035, Uvinul® 3035 ethoxylated with Pluriol A 3050 E, Uvinul® N 539, Uvinul® A Plus, Uvinul® 3000, Uvinul® 3040, Uvinul® 3040 ethoxylated with Pluriol A 3050 E, TiO₂, a-tocopherol, diphenylamine, resveratrol, abscisic acid and n-propylgallate.

According to another embodiment of the present invention, the light detoxifying compound B is preferably selected from the group consisting of B.1.1, B.1.5, B.1.7, B.1.11 and B.1.16; more preferably selected from the group consisting of Tinosorb® M, Uvinul® MC 80, Uvinul® MS 40, Uvinul® T 150 and Tinosorb® FD.

According to another embodiment of the present invention, the light detoxifying compound B is preferably selected from the group consisting of B.1.1, B1.2, B.1.5, B.1.6, B.1.7, B.1.11, B.1.16, B.2.2, B.3.4, B.3.19, B.3.27, B.3.28 and B.3.29; more preferably selected from the group consisting of Tinosorb® M, Uvinul® 3035, Uvinul® 3035 ethoxylated with Pluriol A 3050 E, Uvinul® N 539, Uvinul® MC 80, Uvinul® A Plus, Uvinul® 3000, Uvinul® 3040, Uvinul® 3040 ethoxylated with Pluriol A 3050 E, Uvinul® MS 40, Uvinul® T 150, Tinosorb® FD, TiO₂, a-tocopherol, diphenylamine, resveratrol, abscisic acid and n-propylgallate.

The organic moieties mentioned herein, especially in the definition of the substituents R¹ to R²⁹, are—like the term halogen—collective terms for individual enumerations of the individual group members. All hydrocarbon chains, i.e. all alkyl, can be straight-chain or branched, the prefix Cₙ-Cₘ denoting in each case the possible number of carbon atoms in the group.

Examples of such meanings are:
C₁-C₄-alkyl also the alkyl moieties of C₁-C₄-alkoxy-C₁-C₄-alkyl and hydroxy-C₁-C₄-alkoxy-C₁-C₄-alkyl: CH₃, C₂H₅, n-propyl, CH(CH₃)₂, n-butyl, CH(CH₃)—C₂H₅, CH₂CH(CH₃)₂ and C(CH₃)₃;
C₁-C₆-alkyl: C₁-C₄-alkyl as mentioned above, and also, for example, n-pentyl, 1-methylbutyl, 2-methylbutyl, 3-methylbutyl, 2,2-dimethylpropyl, 1-ethylpropyl, n-hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethyl-butyl, 2,2-dimethylbutyl, 2,3-dimethylbutyl, 3,3-dimethylbutyl, 1-ethylbutyl, 2-ethyl-butyl, 1,1,2-trimethylpropyl, 1,2,2-trimethylpropyl, 1-ethyl-1-methylpropyl or 1-ethyl-2-methylpropyl, preferably methyl, ethyl, n-propyl, 1-methylethyl, n-butyl, 1,1-dimethylethyl, n-pentyl or n-hexyl;
C₁-C₄-hydroxyalkyl: for example hydroxymethyl, 1-hydroxyeth-1-yl, 2-hydroxyeth-1-yl, 1-hydroxyprop-1-yl, 2-hydroxyprop-1-yl, 3-hydroxyprop-1-yl, 1-hydroxyprop-2-yl, 2-hydroxyprop-2-yl, 1-hydroxybut-1-yl, 2-hydroxybut-1-yl, 3-hydroxybut-1-yl, 4-hydroxybut-1-yl, 1-hydroxybut-2-yl, 2-hydroxybut-2-yl, 1-hydroxybut-3-yl, 2-hydroxybut-3-yl, 1-hydroxy-2-methylprop-3-yl, 2-hydroxy-2-methylprop-3-yl, 3-hydroxy-2-methylprop-3-yl and 2-hydroxymethylprop-2-yl, 1,2-dihydroxyethyl, 1,2-dihydroxyprop-3-yl, 2,3-dihydroxyprop-3-yl, 1,2-dihydroxyprop-2-yl, 1,2-dihydroxybut-4-yl, 2,3-dihydroxybut-4-yl, 3,4-dihydroxybut-4-yl, 1,2-dihydroxybut-2-yl, 1,2-dihydroxybut-3-yl, 2,3-dihydroxybut-3-yl, 1,2-dihydroxy-2-methylprop-3-yl, 2,3-dihydroxy-2-methylprop-3-yl;
C₁-C₄-alkoxy also the alkoxy moieties of C₁-C₄-alkoxy-C₁-C₄-alkyl and hydroxy-C₁-C₄-alkoxy-C₁-C₄-alkyl: for example methoxy, ethoxy, propoxy, 1-methylethoxy, butoxy, 1-methylpropoxy, 2-methylpropoxy and 1,1-dimethylethoxy.

The compositions according to the invention are suitable as herbicides and show an enhanced herbicidal activity against unwanted plants. They are suitable as such or as an appropriately formulated composition. The compositions according to the invention control vegetation on non-crop areas very efficiently, especially at high rates of application. They act against broad-leafed weeds and grass weeds in crops such as wheat, rice, corn, soybeans and cotton without causing any significant damage to the crop plants. This effect is mainly observed at low rates of application.

Surprisingly it has been found that the enhanced herbicidal activity of the compositions according to the present invention preferably is an enhanced foliar activity and/or an enhanced regrowth control activity (enhanced long-term activity) against unwanted plants.

Accordingly a specific embodiment of the present application relates to a method for controlling unwanted vegetation

Accordingly a specific embodiment of the present application relates to a method to enhance the foliar activity against unwanted plants, preferably the foliar activity of PPO inhibitors against unwanted plants; more preferably the foliar activity of PPO inhibitors under high light conditions against unwanted plants.

Another specific embodiment of the present application relates to a method to enhance the regrowth control activity against unwanted plants,

preferably the regrowth control activity of PPO inhibitors against unwanted plants;

more preferably the regrowth control activity of PPO inhibitors under high light conditions against unwanted plants.

Light can be quantified in Lux [lx] or per unit surface and unit time as photon irradiance expressed in [mol m⁻² s⁻¹] according to Bjorn and Vogelmann, Photochem. Photobiol. 1996, 64, 403-406 using light measuring instruments (e.g. Li-COR inc. Model Li 185B Quantum/radiometer/photometer, Bachofer, Reutlingen, Germany).

The term “high light conditions” stands for 3000 to 100 μmol m⁻² s⁻¹ (which is equivalent to approximately 150 000 to 5000 lx), preferably for 2000 to 200 μmol m⁻² s⁻¹ (which is equivalent to approximately 100 000 to 10 000 lx).

The term “low light conditions” stands for 1 to 100 μmol m⁻² s⁻¹ (which is equivalent to approximately 50 to 5000 lx), preferably for 2 to 70 μmol m⁻² s⁻¹ (which is equivalent to approximately 100 to 3500 lx.

Depending on the application method in question, the compositions according to the present invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera and Zea mays.

Preferred crops are the following: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (S. vulgare), Triticale, Triticum aestivum, Triticum durum, Vicia faba, Vitis vinifera and Zea mays.

The compositions according to the invention can also be used in genetically modified plants. The term “genetically modified plants” is to be understood as plants whose genetic material has been modified by the use of recombinant DNA techniques to include an inserted sequence of DNA that is not native to that plant species' genome or to exhibit a deletion of DNA that was native to that species' genome, wherein the modification(s) cannot readily be obtained by cross breeding, mutagenesis or natural recombination alone. Often, a particular genetically modified plant will be one that has obtained its genetic modification(s) by inheritance through a natural breeding or propagation process from an ancestral plant whose genome was the one directly treated by use of a recombinant DNA technique. Typically, one or more genes have been integrated into the genetic material of a genetically modified plant in order to improve certain properties of the plant. Such genetic modifications also include but are not limited to targeted post-translational modification of protein(s), oligo- or polypeptides. e.g. by inclusion therein of amino acid mutation(s) that permit, decrease, or promote glycosylation or polymer additions such as prenylation, acetylation farnesylation, or PEG moiety attachment.

Plants that have been modified by breeding, mutagenesis or genetic engineering, e.g. have been rendered tolerant to applications of specific classes of herbicides, such as auxin herbicides such as dicamba or 2,4-D; bleacher herbicides such as hydroxy-phenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase inhibitors; lipid biosynthesis inhibitors such as acetyl CoA carboxylase (ACCase) inhibitors; or oxynil (i.e. bromoxynil or ioxynil) herbicides as a result of conventional methods of breeding or genetic engineering; furthermore, plants have been made resistant to multiple classes of herbicides through multiple genetic modifications, such as resistance to both glyphosate and glufosinate or to both glyphosate and a herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Several cultivated plants have been rendered tolerant to herbicides by conventional methods of breeding (mutgenesis), e.g. Clearfield® summer rape (Canola, BASF SE, Germany) being tolerant to imidazolinones, e.g. imazamox, or ExpressSun® sunflowers (DuPont, USA) being tolerant to sulfonyl ureas, e.g. tribenuron. Genetic engineering methods have been used to render cultivated plants such as soybean, cotton, corn, beets and rape, tolerant to herbicides such as glyphosate, imidazolinones and glufosinate, some of which are under development or commercially available under the brands or trade names RoundupReady® (glyphosate tolerant, Monsanto, USA), Cultivance® (imidazolinone tolerant, BASF SE, Germany) and LibertyLink® (glufosinate tolerant, Bayer CropScience, Germany).

Furthermore, plants are also covered that are by the use of recombinant DNA techniques capable to synthesize one or more insecticidal proteins, especially those known from the bacterial genus Bacillus, particularly from Bacillus thuringiensis, such as delta-endotoxins, e.g., CryIA(b), CryIA(c), CryIF, CryIF(a2), CryIIA(b), CryIIIA, CryIIIB(b1) or Cry9c; vegetative insecticidal proteins (VIP), e.g., VIP1, VIP2, VIP3 or VIP3A; insecticidal proteins of bacteria colonizing nematodes, e.g., Photorhabdus spp. or Xenorhabdus spp.; toxins produced by animals, such as scorpion toxins, arachnid toxins, wasp toxins, or other insect-specific neurotoxins; toxins produced by fungi, such as Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilbene synthase, bibenzyl synthase, chitinases or glucanases. In the context of the present invention these insecticidal proteins or toxins are to be understood expressly also as including pre-toxins, hybrid proteins, truncated or otherwise modified proteins. Hybrid proteins are characterized by a new combination of protein domains, (see, e.g., WO 02/015701). Further examples of such toxins or genetically modified plants capable of synthesizing such toxins are disclosed, e.g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e.g., in the publications mentioned above. These insecticidal proteins contained in the genetically modified plants impart to the plants producing these proteins tolerance to harmful pests from all taxonomic groups of arthropods, especially to beetles (Coeloptera), two-winged insects (Diptera), and moths (Lepidoptera) and to nematodes (Nematoda). Genetically modifled plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g., Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S. A., Belgium (corn cultivars producing the Cry3Bb1 toxin), IPC 531 from Monsanto Europe S. A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g., EP-A 392 225), plant disease resistance genes (e.g., potato culti-vars, which express resistance genes acting against Phytophthora infestans derived from the Mexican wild potato, Solanum bulbocastanum) or T4-lyso-zym (e.g., potato cultivars capable of synthesizing these proteins with increased resistance against bacteria such as Erwinia amylovora).

The methods for producing such genetically modi-fied plants are generally known to the person skilled in the art and are described, e.g., in the publications mentioned above.

Furthermore, plants are also covered that are by the use of recombinant DNA techniques capable to synthesize one or more proteins to increase the productivity (e.g., bio-mass production, grain yield, starch content, oil content or protein content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of ingredient or new ingredient, specifically to improve human or animal nutrition, e.g., oil crops that produce health-promoting long-chain omega-3 fatty acids or unsaturated omega-9 fatty acids (e.g., Nexera® rape, Dow AgroSciences, Canada).

Furthermore, plants are also covered that contain by the use of recombinant DNA techniques a modified amount of substances of content or new substances of content, specifically to improve raw material production, e.g., potatoes that produce increased amounts of amylopectin (e.g. Amflora® potato, BASF SE, Germany).

Furthermore, it has been found that the compositions according to the present invention are also suitable for the defoliation and/or desiccation of plant parts, for which crop plants such as cotton, potato, oilseed rape, sunflower, soybean or field beans, in particular cotton, are suitable. In this regard, compositions for the desiccation and/or defoliation of plants, processes for preparing these compositions and methods for desiccating and/or defoliating plants using the compositions according to the present invention have been found.

As desiccants, the compositions according to the present invention are particularly suitable for desiccating the above-ground parts of crop plants such as potato, oilseed rape, sunflower and soybean, but also cereals. This makes possible the fully mechanical harvesting of these important crop plants.

Also of economic interest is to facilitate harvesting, which is made possible by concentrating within a certain period of time the dehiscence, or reduction of adhesion to the tree, in citrus fruit, olives and other species and varieties of pernicious fruit, stone fruit and nuts. The same mechanism, i.e. the promotion of the development of abscission tissue between fruit part or leaf part and shoot part of the plants is also essential for the controlled defoliation of useful plants, in particular cotton.

Moreover, a shortening of the time interval in which the individual cotton plants mature leads to an increased fiber quality after harvesting.

The compositions according to the invention or the crop protection compositions comprising them or formulated therefrom can be used, for example, in the form of ready-to-spray aqueous solutions, powders, suspensions, also highly concentrated aqueous, oily or other suspensions or dispersions, emulsions, oil dispersions, pastes, dusts, materials for broadcasting, or granules, by means of spraying, atomizing, dusting, spreading, watering or treatment of the seed or mixing with the seed. The use forms depend on the intended purpose; in any case, they should ensure the finest possible distribution of the active ingredients according to the invention.

The crop protection compositions comprise an herbicidal effective amount of the composition according to the invention, i.e. at least one herbicide A, at least one light detoxifying compound B and auxiliaries customary for formulating crop protection agents.

Examples of auxiliaries customary for the formulation of crop protection agents are inert auxiliaries, solid carriers, surfactants (such as dispersants, protective colloids, emulsifiers, wetting agents and tackifiers), organic and inorganic thickeners, bactericides, antifreeze agents, antifoams, optionally colorants and, for seed formulations, adhesives.

The person skilled in the art is sufficiently familiar with the recipes for such formulations.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R. T. Vanderbilt), and also organic and inorganic sheet minerals, such as Attaclay® (from Engelhardt).

Examples of antifoams are silicone emulsions (such as, for example, Silikon® SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on dichlorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide MBS from Thor Chemie).

Examples of antifreeze agents are ethylene glycol, propylene glycol, urea or glycerol.

Examples of colorants are both sparingly water-soluble pigments and water-soluble dyes. Examples which may be mentioned are the dyes known under the names

Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives are polyvinylpyrrolidone, polyvinyl acetate, polyvinyl alcohol and tylose.

Suitable inert auxiliaries are, for example, the following: mineral oil fractions of medium to high boiling point, such as kerosene and diesel oil, furthermore coal tar oils and oils of vegetable or animal origin, aliphatic, cyclic and aromatic hydrocarbons, for example paraffin, tetrahydronaphthalene, alkylated naphthalenes and their derivatives, alkylated benzenes and their derivatives, alcohols such as methanol, ethanol, propanol, butanol and cyclohexanol, ketones such as cyclohexanone or strongly polar solvents, for example amines such as N-methylpyrrolidone, and water.

Suitable carriers include liquid and solid carriers.

Liquid carriers include e.g. non-aqeuos solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof.

Solid carriers include e.g. mineral earths such as silicas, silica gels, silicates, talc, kaolin, limestone, lime, chalk, bole, loess, clay, dolomite, diatomaceous earth, calcium sulfate, magnesium sulfate and magnesium oxide, ground synthetic materials, fertilizers such as ammonium sulfate, ammonium phosphate, ammonium nitrate and ureas, and products of vegetable origin, such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers-types, Borregaard), phenolsulfonic acids, naphthalenesulfonic acids (Morwet types, Akzo Nobel) and dibutylnaphthalenesulfonic acid (Nekal types, BASF AG), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol types Clariant), polycarboxylates (BASF AG, Sokalan types), polyalkoxylates, polyvinylamine (BASF AG, Lupamine types), polyethyleneimine (BASF AG, Lupasol types), polyvinylpyrrolidone and copolymers thereof.

Powders, materials for broadcasting and dusts can be prepared by mixing or concomitant grinding the active ingredients together with a solid carrier.

Granules, for example coated granules, impregnated granules and homogeneous granules, can be prepared by binding the active ingredients to solid carriers.

Aqueous use forms can be prepared from emulsion concentrates, suspensions, pastes, wettable powders or water-dispersible granules by adding water. To prepare emulsions, pastes or oil dispersions, the . . . of the formula I, either as such or dissolved in an oil or solvent, can be homogenized in water by means of a wetting agent, tackifier, dispersant or emulsifier. Alternatively, it is also possible to prepare concentrates comprising active compound, wetting agent, tackifier, dispersant or emulsifier and, if desired, solvent or oil, which are suitable for dilution with water.

In the formulation of the compositions according to the present invention the active ingredients are present in suspended, emulsified or dissolved form. The formulation according to the invention can be in the form of aqueous solutions, powders, suspensions, also highly-concentrated aqueous, oily or other suspensions or dispersions, aqueous emulsions, aqueous microemulsions, aqueous suspo-emulsions, oil dispersions, pastes, dusts, materials for spreading or granules.

The compositions according to the present invention can, for example, be formulated as follows:

1. Products for Dilution with Water

A water-soluble concentrates

10 parts by weight of active compound are dissolved in 90 parts by weight of water or a water-soluble solvent. As an alternative, wetters or other adjuvants are added. The active compound dissolves upon dilution with water. This gives a formulation with an active compound content of 10% by weight.

B Dispersible Concentrates

20 parts by weight of active compound are dissolved in 70 parts by weight of cyclohexanone with addition of 10 parts by weight of a dispersant, for example polyvinylpyrrolidone. Dilution with water gives a dispersion. The active compound content is 20% by weight.

C Emulsifiable Concentrates

15 parts by weight of active compound are dissolved in 75 parts by weight of an organic solvent (eg. alkylaromatics) with addition of calcium dodecylbenzenesulfonate and castor oil ethoxylate (in each case 5 parts by weight). Dilution with water gives an emulsion. The formulation has an active compound content of 15% by weight.

D Emulsions

25 parts by weight of active compound are dissolved in 35 parts by weight of an organic solvent (eg. alkylaromatics) with addition of calcium dodecylbenzenesulfonate and castor oil ethoxylate (in each case 5 parts by weight). This mixture is introduced into 30 parts by weight of water by means of an emulsifier (Ultraturrax) and made into a homogeneous emulsion. Dilution with water gives an emulsion. The formulation has an active compound content of 25% by weight.

E Suspensions

In an agitated ball mill, 20 parts by weight of active compound are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-Dispersible Granules and Water-Soluble Granules

50 parts by weight of active compound are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

G Water-Dispersible Powders and Water-Soluble Powders

75 parts by weight of active compound are ground in a rotor-stator mill with addition of 25 parts by weight of dispersants, wetters and silica gel. Dilution with water gives a stable dispersion or solution of the active compound. The active compound content of the formulation is 75% by weight.

H Gel Formulations

In a ball mill, 20 parts by weight of active compound, 10 parts by weight of dispersant, 1 part by weight of gelling agent and 70 parts by weight of water or of an organic solvent are mixed to give a fine suspension. Dilution with water gives a stable suspension with active compound content of 20% by weight.

2. Products to be Applied Undiluted

I Dusts

5 parts by weight of active compound are ground finely and mixed intimately with 95 parts by weight of finely divided kaolin. This gives a dusting powder with an active compound content of 5% by weight.

J Granules (GR, FG, GG, MG)

0.5 parts by weight of active compound are ground finely and associated with 99.5 parts by weight of carriers. Current methods here are extrusion, spray-drying or the fluidized bed. This gives granules to be applied undiluted with an active compound content of 0.5% by weight.

K ULV Solutions (UL)

10 parts by weight of active compound are dissolved in 90 parts by weight of an organis solvent, for example xylene. This gives a product to be applied undiluted with an active compound content of 10% by weight.

Aqueous use forms can be prepared from emulsion concentrates, suspensions, pastes, wettable powders or water-dispersible granules by adding water.

The concentrations of the active compounds in the ready-to-use preparations can be varied within wide ranges. In general, the formulations comprise from 0.001 to 98% by weight, preferably 0.01 to 95% by weight of at least one active compound. The active compounds are employed in a purity of from 90% to 100%, preferably 95% to 100% (according to NMR spectrum).

In the ready-to-use preparations, i.e. in the compositions according to the invention in the form of crop protection compositions, the components A and B can be present formulated jointly or separately in suspended, emulsified or dissolved form. The use forms depend entirely on the intended applications.

Accordingly, a first embodiment of the invention relates to compositions in the form of a crop protection composition formulated as a 1-component composition comprising the at least one active compound active compound A and at least one further active compound selected from the compounds B and also a solid or liquid carrier and, if appropriate, one or more surfactants.

Accordingly, a second embodiment of the invention relates to compositions in the form of a crop protection composition formulated as a 2-component composition comprising a first formulation (component) comprising the at least one active compound A, a solid or liquid carrier and, if appropriate, one or more surfactants, and a second component comprising at least one compound B, a solid or liquid carrier and, if appropriate, one or more surfactants.

The compositions according to the invention are applied to the plants mainly by spraying the leaves. Here, the application can be carried out using, for example, water as carrier by customary spraying techniques using spray liquor amounts of from about 100 to 1000 I/ha (for example from 300 to 400 I/ha). The herbicidal compositions may also be applied by the low-volume or the ultra-low-volume method, or in the form of microgranules.

The compositions according to the present invention can be applied pre-, post-emergence or pre-plant, or together with the seed of a crop plant. It is also possible to apply the herbicidal composition or active compounds by applying seed, pretreated with the herbicidal compositions or active compounds, of a crop plant. If the active ingredients are less well tolerated by certain crop plants, application techniques may be used in which the herbicidal compositions are sprayed, with the aid of the spraying equipment, in such a way that as far as possible they do not come into contact with the leaves of the sensitive crop plants, while the active ingredients reach the leaves of undesirable plants growing underneath, or the bare soil surface (post-directed, lay-by).

The required application rate of pure active compound composition, i.e. A and B and, if appropriate, C and/or D without formulation auxiliaries depends on the composition of the plant stand, on the development stage of the plants, on the climatic conditions at the site of use and on the application technique.

In general, the application rate of A and B and, if appropriate, C and/or D, is from 1 to 3000 g/ha, preferably from 5 to 2500 g/ha and in particular from 10 to 2000 g/ha of active substance (a.s.).

The required application rates of the herbicide A are generally in the range of from 0.1 g/ha to 3000 g/ha, and preferably in the range of from 10 g/ha to 1000 g/ha of a.s.

In another embodiment of the invention, the application rates of the herbicide A are generally in the range of from 5 g/ha to 2500 g/ha and preferably in the range of from 5 g/ha to 2000 g/ha or 10 g/ha to 1500 g/h of a.s

In another preferred embodiment of the invention, the application rates of the herbicide A are in the range from 0.1 g/ha to 5000 g/ha and preferably in the range from 1 g/ha to 2500 g/ha or from 5 g/ha to 2000 g/ha of active substance (a.s.).

In another preferred embodiment of the invention, the application rate of the herbicide A is 0.1 to 1000 g/ha, preferably) to 750 g/ha, more preferably 5 to 500 g/ha, of active substance (a.s.).

The required application rates of the light detoxifying compound B are generally in the range of from 5 g/ha to 2500 g/ha and preferably in the range of from 5 g/ha to 2000 g/ha or 10 g/ha to 1500 g/h of light detoxifying compound B.

In another preferred embodiment of the invention, the application rates of the light detoxifying compound B are in the range from 0.1 g/ha to 10000 g/ha and preferably in the range from 1 g/ha to 7000 g/ha or from 5 g/ha to 7000 g/ha of light detoxifying compound B.

In another preferred embodiment of the invention, the application rate of the light detoxifying compound B is 0.1 to 1000 g/ha, preferablyl to 750 g/ha, more preferably 5 to 500 g/ha, of light detoxifying compound B.

To widen the spectrum of action and to achieve synergistic effects, the compositions according to the present invention may be mixed with a large number of representatives of other herbicidal or growth-regulating active ingredient groups C and then applied concomitantly.

Suitable components C for mixtures are, for example, 1,2,4-thiadiazoles, 1,3,4-thiadiazoles, amides, aminophosphoric acid and its derivatives, aminotriazoles, anilides, (het)aryloxyalkanoic acids and their derivatives, benzoic acid and its derivatives, benzothiadiazinones, 2-aroyl-1,3-cyclohexanediones, 2-hetaroyl-1,3-cyclohexane-diones, hetaryl aryl ketones, benzylisoxazolidinones, meta-CF₃-phenyl derivatives, carbamates, quinolinecarboxylic acid and its derivatives, chloroacetanilides, cyclohexenone oxime ether derivatives, diazines, dichloropropionic acid and its derivatives, dihydrobenzofurans, dihydrofuran-3-ones, dinitroanilines, dinitrophenols, diphenyl ethers, dipyridyls, halocarboxylic acids and their derivatives, ureas, 3-phenyluracils, imidazoles, imidazolinones, N-phenyl-3,4,5,6-tetrahydrophthalimides, oxadiazoles, oxiranes, phenols, aryloxy- and hetaryloxyphenoxypropionic esters, phenylacetic acid and its derivatives, 2-phenylpropionic acid and its derivatives, pyrazoles, phenylpyrazoles, pyridazines, pyridinecarboxylic acid and its derivatives, pyrimidyl ethers, sulfonamides, sulfonylureas, triazines, triazinones, triazolinones, triazolecarboxamides, uracils, phenyl pyrazolines and isoxazolines and derivatives thereof.

The application rates of compounds C are generally in the range from 0.1 g/ha to 5000 g/ha and preferably in the range from 1 g/ha to 2500 g/ha or from 5 g/ha to 2000 g/ha of active substance (a.s.).

According to one embodiment of the present application is directed to compositions comprising

at least one, preferably exactly one, herbicide A;

at least one, preferably exactly one, light detoxifying compound B; and

at least one preferably exactly one, herbicide C.

According to another embodiment of the present application is directed to compositions comprising

at least one, preferably exactly one, herbicide A;

at least one, preferably exactly one, light detoxifying compound B; and

a herbicide C selected from aminophosphoric acid (herbicides C.I.) and its derivatives, especially preferred glyphosate.

According to another embodiment of the present application is directed to compositions comprising

at least one, preferably exactly one, herbicide A.1, especially preferred saflufenacil;

at least one, preferably exactly one, light detoxifying compound B.1; especially preferred Uvinul® 3040 (=Uvinul® M40); and

a herbicide C selected from aminophosphoric acid (herbicides C.I.) and its derivatives, especially preferred glyphosate.

According to another embodiment of the present application is directed to compositions comprising

at least one, preferably exactly one, herbicide A.1, especially preferred saflufenacil;

at least one, preferably exactly one, light detoxifying compound B.1; especially preferred Uvinul® M40;

at least one, preferably exactly one, light detoxifying compound B.3; especially preferred diphenylamine; and

a herbicide C selected from aminophosphoric acid and its derivatives, especially preferred glyphosate.

Moreover, it may be useful to apply the compositions according to the present invention in combination with safeners D.

Safeners are chemical compounds which prevent or reduce damage on useful plants without having a major impact on the herbicidal action of the compositions according to the present invention towards unwanted plants. They can be applied either before sowings (e.g. on seed treatments, shoots or seedlings) or in the pre-emergence application or post-emergence application of the useful plant. The safeners and the compositions according to the present invention can be applied simultaneously or in succession.

Suitable safeners are e.g. (quinolin-8-oxy)acetic acids, 1-phenyl-5-haloalkyl-1H-1,2,4-triazol-3-carboxylic acids, 1-phenyl-4,5-dihydro-5-alkyl-1H-pyrazol-3,5-dicarboxylic acids, 4,5-dihydro-5,5-diary)-3-isoxazol carboxylic acids, dichloroacetamides, alphaoximinophenylacetonitriles, acetophenonoximes, 4,6-dihalo-2-phenylpyrimidines, N-[[4-(aminocarbonyl)phenyl]sulfonyl]-2-benzoic amides, 1,8-naphthalic anhydride, 2-halo-4-(haloalkyl)-5-thiazol carboxylic acids, phosphorthiolates and N-alkyl-O-phenyl-carbamates and their agriculturally acceptable salts and their agriculturally acceptable derivatives such amides, esters, and thioesters, provided they have an acid group.

The application rates of compounds D are generally in the range from 0.1 g/ha to 5000 g/ha and preferably in the range from 1 g/ha to 2500 g/ha or from 5 g/ha to 2000 g/ha of active substance (a.s.).

Moreover, it may be advantageous to apply the compositions of the present invention on their own or jointly in combination with other crop protection agents, for example with agents for controlling pests or phytopathogenic fungi or bacteria or with groups of active compounds which regulate growth. Also of interest is the miscibility with mineral salt solutions which are employed for treating nutritional and trace element deficiencies. Non-phytotoxic oils and oil concentrates can also be added.

The following examples are presented to further illustrate the method of this invention, but are not be construed as limiting the invention.

The compositions according to the invention have better herbicidal activity, i.e. better activity against harmful plants, than would have been expected based on the herbicidal activity observed for the individual compound(s), or a broader activity spectrum.

The herbicidal activity to be expected for mixtures based on the individual compound can be calculated using Colby's formula (Calculating synergistic and antagonistic responses of herbicide combinations, Weeds 15, 1967, p. 22ff.), wherein the value E, which is expected if the activity of the individual active compounds is only additive, can be calculated.

E=X+Y−(X·Y/100)
where
X=percent activity using active compound A at an application rate a;
Y=percent activity using active compound B at an application rate b;
E=expected activity (in %) by A+B at application rates a+b.

If the value found experimentally is higher than the value E calculated according to Colby, a synergistic effect is present.

The plants used in the experiments were of the following species:

| Bayer code | Scientifc name | English name |
|---|---|---|
| ABUTH | Abutilon theophrasti | velvetleaf |
| ERICA | Erigeron canadensis | fleabane |
| PHBPU | Pharbitis purpurea | common morningglory |

### EXAMPLE 1

### Table 1.1 to Table 1.21

Young plants of fleabane (Erigeron canadiensis, ERICA) were raised with soil in plastic pots (diameter 12.5 cm, 500 ml, 1 plant pot⁻¹, 4 replicates) to a growth stage with 9 developed leaves per plant in rosette under controlled greenhouse conditions. In the case of moringglory (Pharbitis purpurea, PHBPU), young plants at the 2^{nd} leaf stage were used.

The whole plants were sprayed with aqueous solutions (700 L ha⁻¹) containing 1% (v/v) crop oil concentrate, 1% (w/v) ammonium sulfate, and at least one formulated light detoxifying compound B. Subsequently the PPO inhibitor was applied as local leaf treatments.

In control pots, the whole plants were sprayed with aqueous solution (700 L ha⁻¹) containing 1% (v/v) crop oil concentrate and 1% (w/v) ammonium sulphate without any light detoxifying compound B and without any subsequent treatment with a PPO inhibitor A.

After treatment, the pots were placed in growth chambers and plants incubated at light/dark cycles, beginning directly after treatment with 8 hours light and 8 hours dark, followed by 16 hours light 18 hours dark cycles at 22° C. 120° C. and 75% relative humidity. Light (1000 μmol m⁻² s⁻¹, equivalent to ca. 50 000 lux) was provided by Osram powerstar HQI-R 250W/NDL and Osram krypton 100 W lamps. After various times of incubation, herbicidal activity with regrowth control was evaluated in 4 replicate plants.

The evaluation of the damage caused by the method and the compositions the according to the present invention was carried out using a scale from 0 to 100%, compared to the untreated control plots. Here, 0 means no damage and 100 means complete destruction (plant necrosis and death) of the plants of a respective weed species.

The following PPO inhibitors (herbicide A) have been used:
A.1.1: saflufenacil formulated as 70% wettable granule (WG) comprising 700 g of saflufenacil per kg WG

The following light detoxifying compounds B have been used:
B.1.2.1: Uvinul® 3035 formulated as SC comprising 200 g of Uvinul® 3035 per litre formulation
B.1.2.2: Uvinul® N 539 formulated as EC comprising 200 g of Uvinul® N 539 per litre formulation
B.1.6.1: Uvinul® A Plus formulated as emulsion concentrate (EC) comprising 100 g of Uvinul® A Plus per litre formulation
B.1.6.2: compound of the formula 1X.1

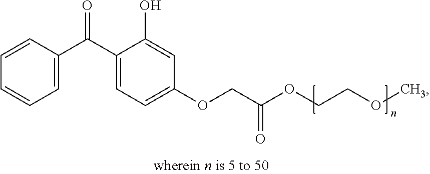

which is Uvinul® 3040 ethoxylated with Pluriol A 3050 E, and
which was used as pure technical compound and added directly to the spraying solution;
B.1.6.3: Uvinul® 3000 formulated as suspension concentrate (SC) comprising 200 g of Uvinul® 3000 per litre formulation;
B.1.6.4: Uvinul® 3040 (=Uvinul® M40) formulated as SC comprising 200 g of Uvinul® 3040 per litre formulation;
B.2.2.1: TiO2 formulated as EC comprising 100 g of TiO₂ per Litre formulation;
B.3.4.1: α-tocopherol, which was added directly to the spraying solution;
B.3.19.1: diphenylamine formulated as EC comprising 100 g of diphenylamine per Litre formulation;
B.3.27.1: resveratrol (trans-3,4″,5-trihydroxystilbene) formulated as EC comprising 100 g of resveratrol per litre formulation;
B.3.28.1: abscisic acid formulated as EC comprising 100 g of abscisic acid per litre formulation;
B.3.29.1: n-propylgallate (n-propyl-3,4,5-trihydroxybenzoate) formulated as EC comprising 300 g of n-propylgallate per litre formulation.

In fleabane two 1 μl droplets of aqueous solutions containing 1% (v/v) crop oil concentrate, 1% (w/v) ammonium sulphate, optionally the (formulated) light quencher B and optionally the PPO inhibitor A were applied with a microsyringe to the adaxial midsection of 5 leaves per plant.

In moringglory ten 1 μl droplets of aqueous solutions containing 1% (vlv) crop oil concentrate, 1% (w/v) ammonium sulphate and optionally the (formulated) light quencher B and optionally the PPO inhibitor A were applied with a microsyringe to the adaxial midsection of the first leaf.

The results are shown in the following tables 1.1 to 1.21:

TABLE 1.1
Herbicidal action of A.1.1 and B.1.2.1 against ERICA

| | |
|---|---|
| application rate in g/ha | % damage |

| | A.1.1 | B.1.2.1 | 7 DAT* | 11 DAT* |
|---|---|---|---|---|
| none (control) | | | 0 | 0 |
| | 60 | — | 10 | 10 |
| | — | 500 | 5 | 0 |
| | 60 | 500 | 53 | 48 |

*DAT: days after treatment

TABLE 1.2
Herbicidal action of A.1.1 and B.1.2.2 against ERICA

| | |
|---|---|
| application rate in g/ha | % damage |

| | A.1.1 | B.1.2.2 | 7 DAT* | 11 DAT* |
|---|---|---|---|---|
| none (control) | | | 0 | 0 |
| | 60 | — | 10 | 10 |
| | — | 500 | 10 | 10 |
| | 60 | 500 | 23 | 15 |

*DAT: days after treatment

TABLE 1.3
Herbicidal action of A.1.1 and B.1.6.1 against ERICA

| | |
|---|---|
| application rate in g/ha | % damage |

| | A.1.1 | B.1.6.1 | 7 DAT* | 11 DAT* |
|---|---|---|---|---|
| none (control) | | | 0 | 0 |
| | 60 | — | 10 | 10 |
| | — | 500 | 0 | 0 |
| | 60 | 500 | 20 | 20 |

*DAT: days after treatment

TABLE 1.4
Herbicidal action of A.1.1 and B.1.6.2 against ERICA

| | |
|---|---|
| application rate in g/ha | % damage |

| | A.1.1 | B.1.6.2 | 10 DAT* | 42 DAT* |
|---|---|---|---|---|
| none (control) | | | 0 | 0 |
| | 60 | — | 56 | 45 |
| | — | 1000 | 0 | 0 |
| | 60 | 500 | 97 | 78 |
| | 60 | 1000 | 100 | 100 |

*DAT: days after treatment

TABLE 1.5
Herbicidal action of A.1.1 and B.1.6.2 against PHBPU

| | |
|---|---|
| application rate in g/ha | % damage |

| | A.1.1 | B.1.6.2 | 4 DAT* | 10 DAT* |
|---|---|---|---|---|
| none (control) | | | 0 | 0 |
| | 60 | — | 28 | 35 |
| | — | 2000 | 26 | 15 |
| | 60 | 500 | 74 | 64 |
| | 60 | 1000 | 89 | 80 |
| | 60 | 2000 | 89 | 88 |

*DAT: days after treatment

TABLE 1.6
Herbicidal action of A.1.1 and B.1.6.3 against ERICA

| | |
|---|---|
| application rate in g/ha | % damage |

| | A.1.1 | B.1.6.3 | 10 DAT* | 42 DAT* |
|---|---|---|---|---|
| none (control) | | | 0 | 0 |
| | 60 | — | 56 | 45 |
| | — | 1000 | 13 | 0 |
| | 60 | 250 | 93 | 63 |
| | 60 | 500 | 91 | 50 |
| | 60 | 1000 | 69 | 8 |

*DAT: days after treatment

TABLE 1.7
Herbicidal action of A.1.1 and B.1.6.3 against PHBPU

| | |
|---|---|
| application rate in g/ha | % damage |

| | A.1.1 | B.1.6.3 | 4 DAT* | 10 DAT* |
|---|---|---|---|---|
| none (control) | | | 0 | 0 |
| | 60 | — | 28 | 35 |
| | — | 2000 | 39 | 20 |
| | 60 | 500 | 50 | 43 |
| | 60 | 1000 | 48 | 58 |
| | 60 | 2000 | 73 | 55 |

*DAT: days after treatment

TABLE 1.8
Herbicidal action of A.1.1 and B.1.6.4 against ERICA

| | |
|---|---|
| application rate in g/ha | % damage |

| | A.1.1 | B.1.6.4 | 10 DAT* | 42 DAT* |
|---|---|---|---|---|
| none (control) | | | 0 | 0 |
| | 60 | — | 56 | 45 |
| | — | 1000 | 0 | 13 |
| | 60 | 250 | 85 | 75 |
| | 60 | 500 | 99 | 90 |
| | 60 | 1000 | 64 | 63 |

*DAT: days after treatment

TABLE 1.9
Herbicidal action of A.1.1 and B.1.6.4 against PHBPU

| | |
|---|---|
| application rate in g/ha | % damage |

| | A.1.1 | B.1.6.4 | 4 DAT* | 10 DAT* |
|---|---|---|---|---|
| none (control) | | | 0 | 0 |
| | 60 | — | 28 | 35 |
| | — | 2000 | 15 | 10 |
| | 60 | 1000 | 38 | 46 |
| | 60 | 2000 | 35 | 23 |

*DAT: days after treatment

TABLE 1.10
Herbicidal action of A.1.1 and B.2.2.1 against ERICA

| | |
|---|---|
| application rate in g/ha | % damage |

| | A.1.1 | B.2.2.1 | 10 DAT* | 42 DAT* |
|---|---|---|---|---|
| none (control) | | | 0 | 0 |
| | 60 | — | 56 | 45 |
| | — | 1000 | 0 | 0 |
| | 60 | 1000 | 93 | 75 |

*DAT: days after treatment

TABLE 1.11
Herbicidal action of A.1.1 and B.2.2.1 against PHBPU

| | |
|---|---|
| application rate in g/ha | % damage |

| | A.1.1 | B.2.2.1 | 4 DAT* | 10 DAT* |
|---|---|---|---|---|
| none (control) | | | 0 | 0 |
| | 60 | — | 28 | 35 |
| | — | 2000 | 21 | 14 |
| | 60 | 500 | 71 | 73 |
| | 60 | 1000 | 40 | 39 |
| | 60 | 2000 | 49 | 48 |

*DAT: days after treatment

TABLE 1.12
Herbicidal action of A.1.1 and B.3.4.1 against ERICA

| | |
|---|---|
| application rate in g/ha | % damage |

| | A.1.1 | B.3.4.1 | 5 DAT* | 11 DAT* |
|---|---|---|---|---|
| none (control) | | | 0 | 0 |
| | 60 | — | 25 | 18 |
| | — | 7000 | 0 | 0 |
| | 60 | 7000 | 40 | 50 |

*DAT: days after treatment

TABLE 1.13
Herbicidal action of A.1.1 and B.3.19.1 against ERICA

| | |
|---|---|
| application rate in g/ha | % damage |

| | A.1.1 | B.3.19.1 | 5 DAT* | 11 DAT* |
|---|---|---|---|---|
| none (control) | | | 0 | 0 |
| | 60 | — | 10 | 10 |
| | — | 1000 | 0 | 0 |
| | 60 | 1000 | 40 | 43 |

*DAT: days after treatment

TABLE 1.14
Herbicidal action of A.1.1 and B.3.29.1 against ERICA

| | |
|---|---|
| application rate in g/ha | % damage |

| | A.1.1 | B.3.29.1 | 5 DAT* | 11 DAT* |
|---|---|---|---|---|
| none (control) | | | 0 | 0 |
| | 60 | — | 10 | 10 |
| | — | 1000 | 0 | 0 |
| | 60 | 1000 | 38 | 38 |

*DAT: days after treatment

TABLE 1.15
Herbicidal action of A.1.1 and B.3.27.1 against ERICA

| | |
|---|---|
| application rate in g/ha | % damage |

| | A.1.1 | B.3.27.1 | 5 DAT* | 11 DAT* |
|---|---|---|---|---|
| none (control) | | | 0 | 0 |
| | 60 | — | 10 | 10 |
| | — | 1000 | 10 | 0 |
| | 60 | 1000 | 25 | 20 |

*DAT: days after treatment

TABLE 1.16
Herbicidal action of A.1.1 and B.3.28.1 against ERICA

| | |
|---|---|
| application rate in g/ha | % damage |

| | A.1.1 | B.3.28.1 | 5 DAT* | 11 DAT* |
|---|---|---|---|---|
| none (control) | | | 0 | 0 |
| | 60 | — | 20 | 19 |
| | — | 1000 | 1 | 0 |
| | 60 | 1000 | 53 | 48 |

*DAT: days after treatment

TABLE 1.17
Herbicidal action of A.1.1, B.1.6.2 and B.3.19.1 against ERICA

| | |
|---|---|
| application rate in g/ha | % damage |

| A.1.1 | B.1.6.2 | B.3.19.1 | 5 DAT* | 11 DAT* |
|---|---|---|---|---|
| none (control) | | | 0 | 0 |
| 60 | — | — | 25 | 18 |
| — | 500 | — | 3 | 0 |
| — | — | 1000 | 0 | 0 |
| 60 | 500 | — | 65 | 55 |
| 60 | 500 | 1000 | 84 | 68 |

*DAT: days after treatment

TABLE 1.18
Herbicidal action of A.1.1, B.1.6.4 and B.3.19.1 against ERICA

| | |
|---|---|
| application rate in g/ha | % damage |

| A.1.1 | B.1.6.4 | B.3.19.1 | 5 DAT* | 11 DAT* |
|---|---|---|---|---|
| none (control) | | | 0 | 0 |
| 60 | — | — | 25 | 18 |
| — | 500 | — | 5 | 5 |
| — | — | 1000 | 0 | 0 |
| 60 | 500 | — | 48 | 20 |
| 60 | 500 | 1000 | 93 | 85 |

*DAT: days after treatment

TABLE 1.19
Herbicidal action of A.1.1, B.1.6.4 and B.3.29.1 against ERICA

| | |
|---|---|
| application rate in g/ha | % damage |

| A.1.1 | B.1.6.4 | B.3.29.1 | 5 DAT* | 11 DAT* |
|---|---|---|---|---|
| none (control) | | | 0 | 0 |
| 60 | — | — | 25 | 18 |
| — | 500 | — | 5 | 5 |
| — | — | 1000 | 5 | 8 |
| 60 | 500 | — | 48 | 20 |
| 60 | 500 | 1000 | 86 | 70 |

*DAT: days after treatment

TABLE 1.20
Herbicidal action of A1.1, B.2.2.1 and B.3.19.1 against ERICA

| | |
|---|---|
| application rate in g/ha | % damage |

| A.1.1 | B.2.2.1 | B.3.19.1 | 5 DAT* | 11 DAT* |
|---|---|---|---|---|
| none (control) | | | 0 | 0 |
| 60 | — | — | 25 | 18 |
| — | 500 | — | 5 | 0 |
| — | — | 1000 | 0 | 0 |
| 60 | 500 | — | 48 | 45 |
| 60 | 500 | 1000 | 65 | 65 |

*DAT: days after treatment

TABLE 1.21
Herbicidal action of A.1.1, B.2.2.1 and B.3.29.1 against ERICA

| | |
|---|---|
| application rate in g/ha | % damage |

| A.1.1 | B.2.2.1 | B.3.29.1 | 5 DAT* | 11 DAT* |
|---|---|---|---|---|
| none (control) | | | 0 | 0 |
| 60 | — | — | 25 | 18 |
| — | 500 | — | 5 | 0 |
| — | — | 1000 | 5 | 8 |
| 60 | 500 | — | 48 | 45 |
| 60 | 500 | 1000 | 58 | 50 |

*DAT: days after treatment

These results clearly show that the compositions according to the present invention comprising at least one herbicide A and at least one light detoxifying compound B show an enhanced herbicidal activity against unwanted plants, specifically not only an enhanced herbicidal activity against unwanted plants per se, but also an enhanced long-term activity against unwanted plants.

### EXAMPLE 2

### Table 2.1 to Table 2.24

Young plant of fleabane (Erigeron canadiensis, ERICA) were raised with soil in plastic pots (diameter 12.5 cm, 500 ml, 1 plant pot⁻¹, 3 replicates) to a growth stage with 9 developed leaves per plant in rosette under controlled greenhouse conditions. Additional experiments with fleabane plants with a growth stage with 2 to 3 rosettes per plant have been proceeded. In the case of morningglory (Pharbitis purpurea, PHBPU), velvet leave (Abutilon theophrasti, ABUTH) and black nightshade (Solanum nigrum, SOLNI), young plants at the 3-4 leaf stage were used.

Whole plants were sprayed with aqueous solutions (375 L ha⁻¹) in the spraying chamber containing 2% (v/v) crop oil concentrate, 1% ammonium sulfate, at least one formulated light detoxifying compound B, and a specific dose of the herbicide A. The dose of the different herbicides A varied from 0.125 to 0.5 g active ingredient ha⁻¹. In control pots, plants were sprayed with water.

After treatment the pots were placed into growth chambers and were incubated at light/dark cycles, beginning directly after treatment with 8 hours light and 8 hours dark, followed by 16 hours light/8 hours dark cycles at 22° C./20° C. and 75% relative humidity. Light (1000 μmol m⁻² s⁻¹, equivalent to ca 50000 lux, 400-750 nm) was provided by Osram powerstar HQI-R 250W/NDL an Osram krypton 100 W lamps. For additional experiments work-in chambers were used with equivalent light conditions.

The herbicidal activity with regrowth control was evaluated in 3 replicates. Results were expressed as mean values of percentage plant damage (0% without plant effects, 100% complete death).

The following PPO inhibitors (herbicide A) have been used:
A.1.1: saflufenacil formulated as 70% WG (wettable granule) comprising 700 g of saflufenacil per kg WG;
A.1.2: CAS 353292-31-6; S-3100 formulated as EC (emulsified concentrate) comprising 50 g of CAS 353292-31-6 per litre;
A.2.1: carfentrazone-ethyl formulated as 50% WG (wettable granule) comprising 500 g of carfentrazone-ethyl per kg WG;
A.4.1: oxyfluorofen formulated as EC (emulsified concentrate) comprising 240 g of oxyfluorfen per litre;
A.5.1: 3-[7-fluoro-3-oxo-4-(prop-2-ynyl)-3,4-dihydro-2H-benzo[1,4]oxazin-6-yl]-1,5-dimethyl-6-thioxo-[1,3,5]triazinan-2,4-dione formulated as EC (emulsified concentrate) comprising 50 g of the active per litre;
A.5.2: flumioxazin formulated as 50% WG comprising 500 g of flumioxazin per kg WG.

The following light detoxifying compounds B have been used:
B.1.2.1: Uvinul® 3035 formulated as SC comprising 200 g of Uvinul® 3035 per litre
B.1.2.2: compound of the formula V11.1

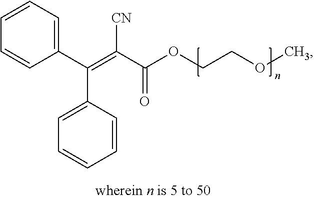

which is Uvinul® 3035 ethoxylated with Pluriol A 3050 E, and which was used as pure technical compound dissolved in crop oil concentrate;
B.1.6.2: compound of the formula 1X.1

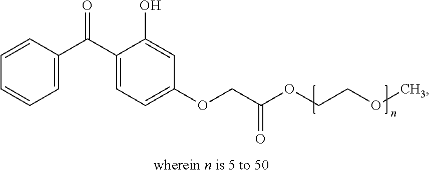

which is Uvinul® 3040 ethoxylated with Pluriol A 3050 E, and which was used as pure technical compound dissolved in crop oil concentrate;
B.1.6.3: Uvinul® 3000 formulated as SC (soluble concentrate) comprising 200 g of Uvinul® 3000 per litre
B.1.6.4: Uvinul® 3040 formulated as SC comprising 200 g of Uvinul® 3040 per litre or used as pure technical compound, dissolved in crop oil concentrate
B.3.29.1: n-propylgallate formulated as EC (emulsified concentrate) comprising 1000 g of n-propylgallate per litre.

The following additional herbicides C have been used:
C.1.1: glyphosate formulated as SL (soluble liquid) comprising 360 g glyphosate per litre.

The results are shown in the following tables 2.1 to 2.24:

TABLE 2.1
Herbicidal action of A.1.1 and B.1.2.1
against ABUTH (growth chamber)

| | |
|---|---|
| application rate in g/ha | % damage |

| A.1.1 | B.1.2.1 | 4 DAT* | 14 DAT* |
|---|---|---|---|
| 0.500 | — | 96 | 83 |
| 0.500 | 1000 | 96 | 92 |

*DAT: days after treatment

TABLE 2.2
Herbicidal action of A.1.1 and B.1.2.1 against
ABUTH and PHBPU (growth chamber)

| | | % damage | | | |
|---|---|---|---|---|---|
| application rate in g/ha | | ABUTH | | PHBPU | |
| A.1.1 | B.1.2.1 | 4 DAT* | 14 DAT* | 4 DAT* | 14 DAT* |
| 0.250 | — | 67 | 35 | 95 | 85 |
| 0.250 | 1000 | 80 | 45 | 96 | 93 |

*DAT: days after treatment

TABLE 2.3
Herbicidal action of A.1.1 and B.1.2.2
against ERICA (walk-in chamber)

| | |
|---|---|
| application rate in g/ha | % damage |

| A.1.1 | B.1.2.2 | 1 DAT* | 4 DAT* | 14 DAT* |
|---|---|---|---|---|
| 0.350 | — | 65 | 90 | 75 |
| 0.350 | 1000 | 77 | 92 | 78 |

*DAT: days after treatment

TABLE 2.4
Herbicidal action of A.1.1 and B.1.6.2
against ERICA (walk-in chamber)

| | |
|---|---|
| application rate in g/ha | % damage |

| A.1.1 | B.1.6.2 | 1 DAT* | 4 DAT* | 14 DAT* |
|---|---|---|---|---|
| 0.125 | — | 38 | 38 | 18 |
| 0.125 | 125 | 45 | 63 | 32 |
| 0.125 | 250 | 75 | 85 | 65 |

*DAT: days after treatment

TABLE 2.5
Herbicidal action of A.1.1 and B.1.6.2
against ERICA (walk-in chamber)

| | |
|---|---|
| application rate in g/ha | % damage |

| A.1.1 | B.1.6.2 | 1 DAT* | 4 DAT* | 14 DAT* |
|---|---|---|---|---|
| 0.350 | — | 65 | 90 | 75 |
| 0.350 | 125 | not evaluated | 96 | 82 |

*DAT: days after treatment

TABLE 2.6
Herbicidal action of A.1.1 and B.1.6.3
against ERICA (walk-in chamber)

| | |
|---|---|
| application rate in g/ha | % damage |

| A.1.1 | B.1.6.3 | 1 DAT* | 4 DAT* | 14 DAT* |
|---|---|---|---|---|
| 0.125 | — | 38 | 38 | 18 |
| 0.125 | 1000 | 50 | 65 | 28 |
| 0.125 | 2000 | 62 | 75 | 57 |

*DAT: days after treatment

TABLE 2.7
Herbicidal action of A.1.1 and B.1.6.4 against
ABUTH and PHBPU (growth chamber)

| | | % damage | | | |
|---|---|---|---|---|---|
| application rate in g/ha | | ABUTH | | PHBPU | |
| A.1.1 | B.1.6.4 | 4 DAT* | 14 DAT* | 4 DAT* | 14 DAT* |
| 0.250 | — | 67 | 35 | 95 | 85 |
| 0.250 | 1000 | 72 | 42 | 98 | 95 |

*DAT: days after treatment

TABLE 2.8
Herbicidal action of A.1.1 and B.1.6.4
against ERICA (walk-in chamber)

| | |
|---|---|
| application rate in g/ha | % damage |

| A.1.1 | B.1.6.4 | 1 DAT* | 4 DAT* | 14 DAT* |
|---|---|---|---|---|
| 0.250 | — | 70 | 83 | 67 |
| 0.250 | 2000 | 90 | 88 | 75 |

*DAT: days after treatment

TABLE 2.9
Herbicidal action of A.1.1 and B.1.6.4
against ERICA (walk-in chamber)

| | |
|---|---|
| application rate in g/ha | % damage |

| A.1.1 | B.1.6.4 | 1 DAT* | 4 DAT* | 14 DAT* |
|---|---|---|---|---|
| 0.350 | — | 65 | 90 | 75 |
| 0.350 | 500 | 73 | 92 | 83 |
| 0.350 | 1000 | 73 | 93 | 80 |

*DAT: days after treatment

TABLE 2.10
Herbicidal action of A.1.1 and B.1.6.4
against PHBPU (growth chamber)

| | |
|---|---|
| application rate in g/ha | % damage |

| A.1.1 | B.1.6.4 | 4 DAT* | 14 DAT* |
|---|---|---|---|
| 0.500 | — | 98 | 93 |
| 0.500 | 1000 | 100 | 100 |

*DAT: days after treatment

TABLE 2.11
Herbicidal action of A.1.1 and B.3.29.1
against ERICA (walk-in chamber)

| | |
|---|---|
| application rate in g/ha | % damage |

| A.1.1 | B.3.29.1 | 1 DAT* | 4 DAT* | 14 DAT* |
|---|---|---|---|---|
| 0.250 | — | 70 | 83 | 67 |
| 0.250 | 500 | 77 | 96 | 80 |

*DAT: days after treatment

TABLE 2.12
Herbicidal action of A.1.2 and B.1.2.1
against ERICA (walk-in chamber)

| | |
|---|---|
| application rate in g/ha | % damage |

| A.1.2 | B.1.2.1 | 4 DAT* | 14 DAT* |
|---|---|---|---|
| 10 | — | 95 | 80 |
| 10 | 1000 | 97 | 95 |

*DAT: days after treatment

TABLE 2.13
Herbicidal action of A.1.2 and B.1.6.4
against PHBPU (walk-in chamber)

| | |
|---|---|
| application rate in g/ha | % damage |

| A.1.2 | B.1.6.4 | 4 DAT* | 14 DAT* |
|---|---|---|---|
| 0.5 | — | 99 | 96 |
| 0.5 | 1000 | 100 | 100 |

*DAT: days after treatment

TABLE 2.14
Herbicidal action of A.2.1 and B.1.2.1
against ERICA (growth chamber)

| | |
|---|---|
| application rate in g/ha | % damage |

| A.2.1 | B.1.2.1 | 4 DAT* | 14 DAT* |
|---|---|---|---|
| 10 | — | 57 | 47 |
| 10 | 1000 | 68 | 50 |

*DAT: days after treatment

TABLE 2.15
Herbicidal action of A.2.1 and B.1.6.2
against ERICA (growth chamber)

| | |
|---|---|
| application rate in g/ha | % damage |

| A.2.1 | B.1.6.2 | 4 DAT* | 14 DAT* |
|---|---|---|---|
| 10 | — | 57 | 47 |
| 10 | 1000 | 80 | 57 |

*DAT: days after treatment

TABLE 2.16
Herbicidal action of A.2.1 and B.1.6.2
against PHBPU (growth chamber)

| | |
|---|---|
| application rate in g/ha | % damage |

| A.2.1 | B.1.6.2 | 4 DAT* | 14 DAT* |
|---|---|---|---|
| 0.5 | — | 94 | 83 |
| 0.5 | 1000 | 95 | 92 |

*DAT: days after treatment

TABLE 2.17
Herbicidal action of A.4.1 and B.1.2.1 against
ABUTH and PHBPU (walk-in chamber)

| | | % damage | | | |
|---|---|---|---|---|---|
| application rate in g/ha | | PHBPU | | ABUTH | |
| A.4.1 | B.1.2.1 | 4 DAT* | 14 DAT* | 4 DAT* | 14 DAT* |
| 20 | — | 99 | 95 | 93 | 80 |
| 20 | 1000 | 99 | 100 | 96 | 83 |

*DAT: days after treatment

TABLE 2.18
Herbicidal action of A.4.1 and B.1.2.1
against PHBPU (walk-in chamber)

| | |
|---|---|
| application rate in g/ha | % damage |

| A.4.1 | B.1.2.1 | 4 DAT* | 14 DAT* |
|---|---|---|---|
| 5 | — | 94 | 83 |
| 5 | 1000 | 98 | 91 |

*DAT: days after treatment

TABLE 2.19
Herbicidal action of A.4.1 and B.1.6.2
against PHBPU (walk-in chamber)

| | |
|---|---|
| application rate in g/ha | % damage |

| A.4.1 | B.1.6.2 | 4 DAT* | 14 DAT* |
|---|---|---|---|
| 5 | — | 94 | 83 |
| 5 | 1000 | 96 | 95 |

*DAT: days after treatment

TABLE 2.20
Herbicidal action of A.5.1 and B.1.2.1
against ABUTH (walk-in chamber)

| | |
|---|---|
| application rate in g/ha | % damage |

| A.5.1 | B.1.2.1 | 4 DAT* | 14 DAT* |
|---|---|---|---|
| 1 | — | 94 | 55 |
| 1 | 1000 | 98 | 100 |

*DAT: days after treatment

TABLE 2.21
Herbicidal action of A.5.1 and B.1.6.2
against ABUTH (walk-in chamber)

| | |
|---|---|
| application rate in g/ha | % damage |

| A.5.1 | B.1.6.2 | 4 DAT* | 14 DAT* |
|---|---|---|---|
| 1 | — | 94 | 55 |
| 1 | 1000 | 98 | 98 |

*DAT: days after treatment

TABLE 2.22
Herbicidal action of A.5.1 and B.1.6.4
against PHBPU (walk-in chamber)

| | |
|---|---|
| application rate in g/ha | % damage |

| A.5.1 | B.1.6.4 | 4 DAT* | 14 DAT* |
|---|---|---|---|
| 0.125 | — | 92 | 70 |
| 0.125 | 1000 | 98 | 85 |

*DAT: days after treatment

TABLE 2.23
Herbicidal action of A.5.2 and B.1.2.1
against ABUTH (growth chamber)

| | |
|---|---|
| application rate in g/ha | % damage |

| A.5.2 | B.1.2.1 | 4 DAT* | 14 DAT* |
|---|---|---|---|
| 2 | — | 98 | 98 |
| 2 | 1000 | 99 | 100 |

*DAT: days after treatment

TABLE 2.24
Herbicidal action of the composition of A.1.1, C.1.1
and B.1.2.1 against PHBPU (growth chamber)

| | |
|---|---|
| application rate in g/ha | % damage |

| A.1.1 | C.1.1 | B.1.2.1 | 4 DAT* | 14 DAT* |
|---|---|---|---|---|
| 0.0625 | 20.5 | — | 33 | 38 |
| 0.0625 | 20.5 | 1000 | 50 | 45 |

*DAT: days after treatment

These results clearly prove that the compositions according to the present invention comprising at least one herbicide A and at least one light detoxifying compound B show an enhanced herbicidal activity against unwanted plants, specifically not only an enhanced herbicidal activity against unwanted plants per se, but also an enhanced long-term activity against unwanted plants.

### EXAMPLE 3

### Table 3.1 to Table 3.14

Young plants of fleabane (Erigeron canadiensis) were raised with soil in plastic pots (diameter 12.5 cm, 500 ml, 1 plant pot⁻¹, 4 replicates) to a growth stage with 9 developed leaves per plant in rosette under controlled greenhouse conditions.

Whole plants were sprayed with aqueous solutions (700 L ha⁻¹) containing 1% (v/v) crop oil concentrate, 1% (w/v) ammonium sulfate, and added formulated component B. Immediately then, component A was applied as local leaf treatments. In fleabane, two 1 μl droplets of aqueous solutions containing 1% (v/v) crop oil concentrate, 1% (w/v) ammonium sulfate, formulated component B and formulated component A were applied with a microsyringe to the adaxial midsection of 5 leaves per plant. In control pots, plants were sprayed with aqueous solution (700 L ha⁻¹) containing 1% (v/v) crop oil concentrate and 1% (w/v) ammonium sulphate, without addition of component B, and subsequent treatment with component A.

After treatment, the pots were placed in growth chambers and plants incubated at light/dark cycles, beginning directly after treatment with 8 hours light and 8 hours dark, followed by 16 hours light 18 hours dark cycles at 22° C./20° C. and 75% relative humidity. Light (1000 μmol m⁻² s⁻¹, equivalent to ca. 50 000 lux, 400-750 nm) was provided by Osram powerstar HQI-R 250W/NDL and Osram krypton 100 W lamps. After various times of incubation, herbicidal activity with regrowth control was evaluated in 4 replicate plants. Results were expressed as mean values of percentage plant damage (0% without plant effects, 100% complete plant necrosis and death) and shown in the following Tables 3.1 to 3.14.

The following PPO inhibitors (herbicide A) have been used:
A.1.1: saflufenacil formulated as 70% wettable granule (WG) comprising 700 g of saflufenacil per kg WG

The following light detoxifying compounds B have been used:
B.1.1.1: Tinosorb® M formulated as SC comprising 500 g Tinosorb® M per litre formulation;
B.1.1.2: Xymara® CarboProtect formulated as EC comprising 100 g Xymara® CarboProtect per litre formulation;
B.1.5.1: Uvinul® MC 80 formulated as EC comprising 200 g of Uvinul® MC 80 per litre formulation;
B.1.6.2: compound of the formula 1X.1

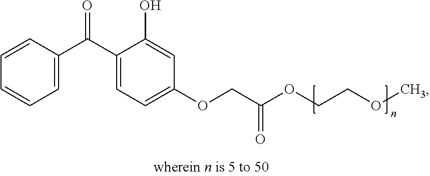

which is Uvinul® 3040 ethoxylated with Pluriol A 3050 E, and
which was used as pure technical compound and added directly to the spraying solution;
B.1.6.4: Uvinul® 3040 (=Uvinul® M40) formulated as SC comprising 200 g of Uvinul® 3040 per litre formulation;
B.1.6.5: 1,1-(1,4-piperazinediyl)bis[1-[2-[4-(diethylamino)-2-hydroxybenzoyl]phenyl]-methanone (CAS919803-06-8) which was used as pure technical compound and added directly to the spraying solution;
B.1.7.1: Uvinul® MS 40 formulated as SL comprising 200 g of Uvinul® MS 40 per litre formulation;
B.1.11.1: Uvinul® T 150 formulated as SC comprising 200 g Uvinul® T 150 per litre formulation;
B.1.16.1: Tinosorb® FD formulated as SC comprising 100 g Tinosorb® FD per litre formulation;
B.1.17.1: 2-cyano-2-[5,5-dimethyl-3-[(1-methylpropyl)amino]-2-cyclohexen-1-ylidene]-acetic acid ethyl ester (CAS1041630-38-9) formulated as EC comprising 100 g of CAS1041630-38-9 per litre formulation;
B.1.18.1: Uvinul®S Pack formulated as SC comprising 100 g Uvinul®S Pack per litre formulation;
B.1.19.1: 3,4,6-trihydroxy-5-oxo-5H-benzocycloheptene-8-carboxylic acid propyl ester
(CAS1283016-28-3) formulated as dispersion concentrate (DC) comprising 100 g of CAS1283016-28-3 per litre formulation;
B.2.1.1: ZnO formulated as SC comprising 200 g of ZnO per Litre formulation;
B.2.2.1: TiO₂ formulated as EC comprising 100 g of TiO₂ per Litre formulation

TABLE 3.1
Herbicidal action of A.1.1 and B.1.1.1 against ERICA

| | |
|---|---|
| application rate in g/ha | % damage |

| | A.1.1 | B.1.1.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 84 | 83 |

*DAT: days after treatment

TABLE 3.2
Herbicidal action of A.1.1 and B.1.1.2 against ERICA

| | |
|---|---|
| application rate in g/ha | % damage |

| | A.1.1 | B.1.1.2 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 82 | 80 |

*DAT: days after treatment

TABLE 3.3
Herbicidal action of A.1.1 and B.1.5.1 against ERICA

| | |
|---|---|
| application rate in g/ha | % damage |

| | A.1.1 | B.1.5.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 98 | 100 |

*DAT: days after treatment

TABLE 3.4
Herbicidal action of A.1.1 and B.1.6.2 against ERICA

| | |
|---|---|
| application rate in g/ha | % damage |

| | A.1.1 | B.1.6.2 | 2 DAT* | 8 DAT* |
|---|---|---|---|---|
| none (control) | | | 0 | 0 |
| | 60 | — | 55 | 34 |
| | — | 1000 | 0 | 0 |
| | 60 | 1000 | 98 | 100 |

*DAT: days after treatment

TABLE 3.5
Herbicidal action of A.1.1 and B.1.6.4 against ERICA

| | |
|---|---|
| application rate in g/ha | % damage |

| | A.1.1 | B.1.6.4 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 94 | 100 |

*DAT: days after treatment

TABLE 3.6
Herbicidal action of A.1.1 and B.1.6.5 against ERICA

| | |
|---|---|
| application rate in g/ha | % damage |

| | A.1.1 | B.1.6.5 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 85 | 78 |

*DAT: days after treatment

TABLE 3.7
Herbicidal action of A.1.1 and B.1.7.1 against ERICA

| | |
|---|---|
| application rate in g/ha | % damage |

| | A.1.1 | B.1.7.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 85 | 83 |

*DAT: days after treatment

TABLE 3.8
Herbicidal action of A.1.1 and B.1.11.1 against ERICA

| | |
|---|---|
| application rate in g/ha | % damage |

| | A.1.1 | B.1.11.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 63 | 90 |

*DAT: days after treatment

TABLE 3.9
Herbicidal action of A.1.1 and B.1.16.1 against ERICA

| | |
|---|---|
| application rate in g/ha | % damage |

| | A.1.1 | B.1.16.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 80 | 100 |

*DAT: days after treatment

TABLE 3.10
Herbicidal action of A.1.1 and B.1.17.1 against ERICA

| | |
|---|---|
| application rate in g/ha | % damage |

| | A.1.1 | B.1.17.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 71 | 74 |
| | — | 1000 | 0 | 0 |
| | 60 | 1000 | 68 | 94 |

*DAT: days after treatment

TABLE 3.11
Herbicidal action of A.1.18.1 and B. against ERICA

| | |
|---|---|
| application rate in g/ha | % damage |

| | A.1.1 | B.1.18.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 81 | 95 |

*DAT: days after treatment

TABLE 3.12
Herbicidal action of A.1.1 and B.1.19.1 against ERICA

| | |
|---|---|
| application rate in g/ha | % damage |

| | A.1.1 | B.1.19.1 | 2 DAT* | 8 DAT* |
|---|---|---|---|---|
| none (control) | | | 0 | 0 |
| | 60 | — | 55 | 34 |
| | — | 250 | 0 | 0 |
| | 60 | 250 | 60 | 55 |
| | — | 500 | 0 | 0 |
| | 60 | 500 | 65 | 40 |

*DAT: days after treatment

TABLE 3.13
Herbicidal action of A.1.1 and B.2.1.1 against ERICA

| | |
|---|---|
| application rate in g/ha | % damage |

| | A.1.1 | B.2.1.1 | 2 DAT* | 8 DAT* |
|---|---|---|---|---|
| none (control) | | | 0 | 0 |
| | 60 | — | 55 | 34 |
| | — | 500 | 0 | 0 |
| | 60 | 500 | 63 | 45 |

*DAT: days after treatment

TABLE 3.14
Herbicidal action of A.1.1 and B.2.2.1 against ERICA

| | |
|---|---|
| application rate in g/ha | % damage |

| | A.1.1 | B.2.2.1 | 2 DAT* | 8 DAT* |
|---|---|---|---|---|
| none (control) | | | 0 | 0 |
| | 60 | — | 55 | 34 |
| | — | 1000 | 5 | 5 |
| | 60 | 1000 | 98 | 100 |

*DAT: days after treatment

The results show the compositions according to the invention comprising at least one herbicide A, in particular saflufenacil, and at least one light detoxifying compound B, in particular selected from UV absorbers B.1, inorganic UV filters B.2 and ROS detoxifying substances B.3, have not only an increased foliar efficiacy but also better weed regrowth control.

1-10. (canceled)

11. A method for controlling unwanted vegetation which comprises allowing an herbicidal active amount of at least one herbicidal composition comprising
a) at least one herbicide A selected from the group consisting of protoporphyrinogen-IX oxidase inhibitors (PPO inhibitors), or at least one agriculturally acceptable salt or derivative thereof, and
b) at least one light detoxifying compound B selected from the group consisting of UV absorbers (B.1), inorganic UV filters (B.2) and ROS detoxifying substances (B.3)
to act on plants, their environment or on seed.

12. The method according to claim 11 wherein the composition is applied in crops of wheat, barley, rye, triticale, durum, rice, corn, sugarcane, sorghum, soybean, pulse crops, peanut, sunflower, sugarbeet, potato, cotton, brassica crops, turf, grapes, pomefruit, stonefruit, citrus, coffee, pistachio, garden ornamentals, bulb ornamentals, onion, garlic, conifers and deciduous trees, drybean, banana, pinneaple, coconut, mango, avocado, guava, eucaliptus, black acacia, rubber tree, palm tree, coacoa, persimmons, pasture, nuts trees, cashnuts tree or pupunha palm.

13. The method according to claim 11 wherein the crop plant is resistant to one or more herbicides owing to genetic engineering or breeding, is resistant to one or more pathogens such as plant pathogenous fungi owing to genetic engineering or breeding, or is resistant to attack by insects owing to genetic engineering or breeding.

14. The method according to claim 11 wherein the composition is applied to a locus where crops will be planted, before planting or before emergence of the crop, for burndown treatment of undesirable vegetation in crops.

15. A herbicidal composition comprising a herbicidal active amount of at least one herbicidal composition comprising
a) at least one herbicide A selected from the group consisting of protoporphyrinogen-IX oxidase inhibitors (PPO inhibitors), or at least one agriculturally acceptable salt or derivative thereof, and
b) at least one light detoxifying compound B selected from the group consisting of UV absorbers (B.1), inorganic UV filters (B.2) and ROS detoxifying substances (B.3)
and at least one inert liquid and/or solid carrier and, if appropriate, at least one surface-active substance.

16. A process for the preparation of herbicidal active compositions as claimed in claim 15, which comprises mixing a herbicidal active amount of at least one herbicidal composition comprising
a) at least one herbicide A selected from the group consisting of protoporphyrinogen-IX oxidase inhibitors (PPO inhibitors), or at least one agriculturally acceptable salt or derivative thereof, and
b) at least one light detoxifying compound B selected from the group consisting of UV absorbers (B.1), inorganic UV filters (B.2) and ROS detoxifying substances (B.3)
and at least one inert liquid and/or solid carrier and, if desired, at least one surface-active substance.

17. An herbicidal composition comprising
a) at least one herbicide A, which is a phenyluracil selected from the group A.1 comprising benzfendizone and compounds of the formula I 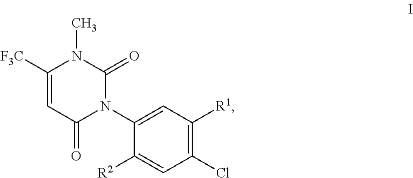
wherein
R¹ is selected from the group consisting of propargyloxy, allyloxy, isopropyloxy, C(═O)NHSO₂NR³R⁴, C(═O)N—NR³R⁴, C(═O)O—CR³R⁵—C(═O)—OR⁷, C(═O)O—R⁴, C(═O)O—CHR⁵—C(═O)NHSO₂NR³R⁴, NHSO₂NR³R⁴, SO₂NHC(═O)NR³R⁴, CH₂—CH(Cl)CO₂—R⁶ and OC(CH₃)₂—C(═O)—OR⁷;
R³ is hydrogen or C₁-C₄-alkyl;
R⁴ is C₁-C₄-alkyl;
R⁵ is hydrogen or C₁-C₄-alkyl;
R⁶ is hydrogen or C₁-C₄-alkyl or a agriculturally acceptable cation; and
R⁷ is C₁-C₄-alkyl, propargyl or allyl;
R² is hydrogen, fluorine or chlorine;
or at least one agriculturally acceptable salt or derivative thereof, and
b) at least one light detoxifying compound B selected from the group consisting of UV absorbers (B.1), inorganic UV filters (B.2) and ROS detoxifying substances (B.3).

18. An herbicidal composition as claimed in claim 17, wherein the herbicide A is saflufenacil.

19. An herbicidal composition as claimed in claim 17 comprising additionally
c) at least one further active compound selected from the group of the herbicides C; and optionally
d) at least one further compound selected from the group of safeners D.

20. A herbicidal composition as claimed in claim 17 comprising additionally at least one further compound selected from the group of safeners D.
